(19) United States
(12) Patent Application Publication
(10) Pub. No.: US 2002/0176503 A1
(43) Pub. Date: Nov. 28, 2002

(54) IMAGE PROCESSING APPARATUS , IMAGE PROCESSING METHOD, AND SUPPLYING MEDIUM

(76) Inventors: OSAMU MATSUNAGA, KANAGAWA (JP); SHIGEO FUJISHIRO, TOKYO (JP)

Correspondence Address: FROMMER LAWRENCE & HAUG, 745 FIFTH AVENUE- 10TH FL., NEW YORK, NY, 10151, US

(21) Appl. No.: 09/392,026

(22) Filed: Sep. 8, 1999

(30) Foreign Application Priority Data
Sep. 9, 1998 (JP) 10-255163

(51) Int. Cl. H04N 7/12

(52) U.S. Cl. 375/240.15

(57) ABSTRACT

A converter partially removes frames of a sequentially scanning image data input to the converter. The resultant data is output to a preprocessing circuit. As a result, the sequentially scanning image data with a frame rate of 60 frames/sec is converted to image data with a frame rate of 30 frames/sec. A prediction error generator 102 calculates prediction error data and outputs the result to a DCT circuit. The DCT circuit performs DCT processing on the prediction error data supplied from the prediction error generator thereby producing DCT coefficients. The obtained DCT coefficients are supplied to a quantizer. The quantizer quantizes the DCT coefficients supplied from the DCT circuit thereby producing quantized data. The quantized data output from the quantizer is supplied to a variable length encoder and a dequantizer. The variable length encoder performs variable length encoding upon the quantized data supplied from the quantizer thereby producing coded image data, The resultant coded image data is output via a buffer. Thus, the given image data to be transmitted is first converted such that the frame rate becomes one-half the original frame rate, and then the image data is encoded.

### BACKGROUND OF THE INVETNION

1. Field of the Invention

The present invention relates to an image processing apparatus, an image processing method, and a supplying medium. More particularly, the present invention relates to an image processing apparatus, an image processing method, and a supplying medium, whereby image data is encoded in a highly efficient fashion.

2. Description of the Related Art

FIG. 30 illustrates an example of the construction of a conventional image encoding apparatus 1. This image encoding apparatus 1 receives one of input image data: image data to be transmitted at a rate of 60 frames/sec such as image data produced by means of sequentially scanning (hereinafter referred to as sequentially scanning image data); or image data to be transmitted at a rate of 30 frames/sec such as image data produced by means of interlaced scanning (hereinafter referred to as interlaced scanning image data).

A preprocessing circuit 101 converts each frame of input image data in either a sequentially scanning or interlaced scanning form constructed in units of rasters into image data constructed in units of macroblocks each consisting of 16×16 pixels. The preprocessing circuit 101 also assigns a picture type (I-picture, B-picture, or P-picture) to each frame and rearranges a sequence of frames in accordance with the assigned picture type. The resultant data is output to a prediction error generator 102 and a motion vector detector 110. In the rearrangement of frames, the preprocessing circuit 101 places B-picture frames, prior in time to I-picture or P-picture frames, at locations following the I-picture and P-picture frames. As a result, I-picture and P-picture frames are encoded prior to the corresponding B-picture frames.

A subtractor serving as a prediction error generator 102 calculates the difference between predicted image data supplied from a motion compensation circuit 109 and image data supplied from the preprocessing circuit 101 thereby producing prediction error data. The resultant prediction error data is output to a DCT circuit 103.

The DCT circuit 103 generates DCT coefficients by performing DCT (discrete cosine transformation) on the prediction error data supplied from the prediction error generator 102. The resultant DCT coefficients are output to a quantizer 104.

According to a quantization step given by a rate control circuit 113, the quantizer 104 quantizes the DCT coefficients supplied from the DCT circuit 103 thereby producing quantized data. The resultant quantized data is output to a dequantizer 105 and a variable length encoder 111.

The dequantizer 105 produces deqauntized data by dequantizing the quantized data supplied from the quantizer 104 using the same quantization step as that employed by the quantizer 104. The resultant dequantized data is output to an inverse DCT circuit 106. The inverse DCT circuit 106 performs inverse DCT on the dequantized data supplied from the dequantizer 105 and outputs resultant data to an adder 107. The adder 107 calculates the sum of the data supplied from the inverse DCT circuit 106 and the predicted image data supplied from the motion compensation circuit 109 and outputs resultant data to a frame memory 108. The quantized data output from the quantizer 104 is locally decoded via the above-described process performed by the dequantizer 105 to the adder 107, and the resultant data is stored in the frame memory 108.

A motion vector detector 110 calculates a motion vector from the image data supplied from the preprocessing circuit 101 and outputs resultant data to the motion compensation circuit 109. In accordance with the motion vector output from the motion vector detector 110, the motion compensation circuit 109 performs motion compensation on the locally decoded image data stored in the frame memory 108, thereby generating predicted image data associated with the image data input to the prediction error generator 102. The resultant predicted image data is outputs to the prediction error generator 102.

An encoder 100 is formed of the circuit elements from the preprocessing circuit 101 to the motion compensation circuit 109.

The variable length encoder 111 performs variable length encoding on the quantized data received from the quantizer 104 thereby generating coded image data. The resultant coded image data is output to a buffer 112. The buffer 112 temporarily stores the coded image data received from the variable length encoder 111 and sequentially outputs the coded image data at a predetermined rate.

The rate control circuit 113 monitors the amount of coded image data stored in the buffer 112, that is, the quantity of codes stored in the buffer 112. The rate control circuit 113 determines the quantization step depending on the amount of coded image data stored in the buffer 112 and sends the determined quantization step to the quantizer 104 thereby controlling the rate at which variable length codes are generated.

When the image encoding apparatus 1 deals with (encodes) sequentially scanning image data, the sequentially scanning image data is encoded in a higher compression efficiency than interlaced scanning image data, because sequentially scanning image data has higher correlations among pixels in terms of positions in a vertical direction and also in terms of time than interlaced scanning image data.

However, in contrast to interlaced scanning image data which is transmitted at a rate of 30 frames/sec, sequentially scanning data is transmitted at a rate of 60 frames/sec. Therefore, when sequentially scanning data is encoded, as greater an amount of coded data is generated as twice the amount of data generated for interlaced scanning image data. Thus, a wider transmission band is required to transmit coded sequentially scanning image data. However, it is generally difficult to find such a wide transmission band for transmitting image data.

On the other hand, although interlaced scanning image data can be encoded into a less amount of coded data than sequentially scanning image data and thus it needs a narrower transmission band, the problem of the interlaced scanning image data is a low compression encoding efficiency.

In view of the above, it is an object of the present invention to provide a technique of encoding and decoding image data in a more efficient fashion while maintaining a high compression efficiency.

### SUMMARY OF THE INVENTION

According to a first aspect of the present invention, there is provided an image processing apparatus comprising: producing means for producing second image data with a second frame rate by partially removing frames of first image data with a first frame rate; first encoding means for encoding the second image data; interpolated frame producing means for producing an interpolated frame from decoded image data obtained by decoding the second image data encoded by the first encoding means; calculating means for calculating the difference between the first image data and the image data of the interpolated frame produced by the interpolated frame producing means; and second encoding means for encoding the difference calculated by the calculating means.

According to a second aspect of the present invention, there is provided an image processing method comprising: a producing step for producing second image data with a second frame rate by partially removing frames of first image data with a first frame rate; a first encoding step for encoding the second image data; an interpolated frame producing step for producing an interpolated frame from decoded image data obtained by decoding the second image data encoded in the first encoding step; a calculating step for calculating the difference between the first image data and the image data of the interpolated frame produced in the interpolated frame producing step; and a second encoding step for encoding the difference calculated in the calculating step.

According to a third aspect of the present invention, there is provided a supplying medium for supplying a computer readable program executed by an image processing apparatus to perform a process comprising: a producing step for producing second image data with a second frame rate by partially removing frames of first image data with a first frame rate; a first encoding step for encoding the second image data; an interpolated frame producing step for producing an interpolated frame from decoded image data obtained by decoding the second image data encoded in the first encoding step; a calculating step for calculating the difference between the first image data and the image data of the interpolated frame produced in the interpolated frame producing step; and a second encoding step for encoding the difference calculated in the calculating step.

In the image processing apparatus according to the first aspect, the image processing method according to the second aspect, and the supplying means according to the third aspects, second image data with the second frame rate is produced by partially removing frames of first image data with the first frame rate. This second image data is then encoded. On the other hand, an interpolated frame is produced from decoded image data obtained by decoding the coded second image data. The difference between the first image data and the image data of the interpolated frame produced is then calculated. The calculated difference is then encoded.

According to a fourth aspect of the present invention, there is provided an image processing apparatus comprising: conversion means for converting the frame rate of received coded image data, whose frame rate has been converted from a first frame rate to a second frame rate, into the original frame rate; producing means for producing difference data for use in decoding the coded image data; and decoding means for decoding the coded image data on the basis of the difference data produced by the producing means.

According to a fifth aspect of the present invention, there is provided an image processing method comprising: a conversion step for converting the frame rate of received coded image data, whose frame rate has been converted from a first frame rate to a second frame rate, into the original frame rate; a producing step for producing difference data for use in decoding the coded image data; and a decoding step for decoding the coded image data on the basis of the difference data produced in the producing step.

According to a sixth aspect of the present invention, there is provided a supplying medium for supplying a computer readable program executed by an image processing apparatus to perform a process comprising: a conversion step for converting the frame rate of received coded image data, whose frame rate has been converted from a first frame rate to a second frame rate, into the original frame rate; a producing step for producing difference data for use in decoding the coded image data; and a decoding step for decoding the coded image data on the basis of the difference data produced in the producing step.

In the image processing apparatus according to the fourth aspect, the image processing method according to the fifth aspect, and the supplying means according to the sixth aspect, the frame rate of received coded image data, whose frame rate has been converted from the first frame rate to the second frame rate, is converted into the original frame rate, and difference data for use in decoding the coded image data is produced. On the basis of the difference data, the coded image data is decoded.

### BRIEF DESCRIPTION OF THE DRAWINGS

FIG. 1 is a block diagram illustrating an example of the construction of an image data communication system according to the present invention;

FIG. 2 is a block diagram illustrating a first embodiment of the image encoder 10 shown in FIG. 1, according the present invention;

FIG. 3 is a schematic representation of an encoding process;

FIG. 4 is a schematic representation of the data structure of a transmission data packet;

FIG. 5 is a schematic representation of the data structure of image data including a still image;

FIG. 6 is a block diagram illustrating a second embodiment of the image encoder 10 shown in FIG. 1, according to the present invention;

FIG. 7 is a block diagram illustrating a first embodiment of the image decoder 13 shown in FIG. 1, according to the present invention;

FIG. 8 is a block diagram illustrating a third embodiment of the image encoder 10 shown in FIG. 1, according to the present invention;

FIG. 9 is a schematic representation of an encoding process;

FIG. 10 is a block diagram illustrating a fourth embodiment of the image encoder 10 shown in FIG. 1, according to the present invention;

FIG. 11 is a block diagram illustrating a second embodiment of the image decoder 13 shown in FIG. 1, according to the present invention;

FIG. 12 is a block diagram illustrating a fifth embodiment of the image encoder 10 shown in FIG. 1, according to the present invention;

FIG. 13 illustrates examples of interpolated frames produced by a motion vector detector 631;

FIG. 14 illustrates examples of interpolated frames produced by the motion vector detector 631;

FIG. 15 illustrates examples of interpolated frames produced by the motion vector detector 631;

FIG. 16 illustrates examples of interpolated frames produced by the motion vector detector 631;

FIG. 17 is a table summarizing various methods of producing interpolated frames;

FIG. 18 is a block diagram illustrating a sixth embodiment of the image encoder 10 shown in FIG. 1, according to the present invention;

FIG. 19 is a block diagram illustrating a seventh embodiment of the image encoder 10 shown in FIG. 1, according to the present invention;

FIG. 20 is a schematic diagram illustrating another example of the data structure of a transmission data packet;

FIG. 21 is a block diagram illustrating an eighth embodiment of the image encoder 10 shown in FIG. 1, according to the present invention;

FIG. 22 is a block diagram illustrating a third embodiment of the image decoder 13 shown in FIG. 1, according to the present invention;

FIG. 23 is a block diagram illustrating a ninth embodiment of the image encoder 10 shown in FIG. 1, according to the present invention;

FIG. 24 is a block diagram illustrating a fourth embodiment of the image decoder 13 shown in FIG. 1, according to the present invention;

FIG. 25 is a block diagram illustrating a tenth embodiment of the image encoder 10 shown in FIG. 1, according to the present invention;

FIG. 26 is a block diagram illustrating an eleventh embodiment of the image encoder 10 shown in FIG. 1, according to the present invention;

FIG. 27 is a block diagram illustrating a fifth embodiment of the image decoder 13 shown in FIG. 1, according to the present invention;

FIG. 28 is a block diagram illustrating a twelfth embodiment of the image encoder 10 shown in FIG. 1, according to the present invention;

FIG. 29 is a block diagram illustrating a sixth embodiment of the image decoder 13 shown in FIG. 1, according to the present invention; and

FIG. 30 is a block diagram illustrating a conventional image encoder.

### DESCRIPTION OF THE PREFERRED EMBODIMENT

The present invention is described in further detail below with reference to preferred embodiments. In order to provide a clear understanding of the correspondence between means and specific elements in the image processing apparatus according to the invention, specific examples of elements are described in parentheses following the corresponding means. However, it should be understood that the means are not limited to those specific examples.

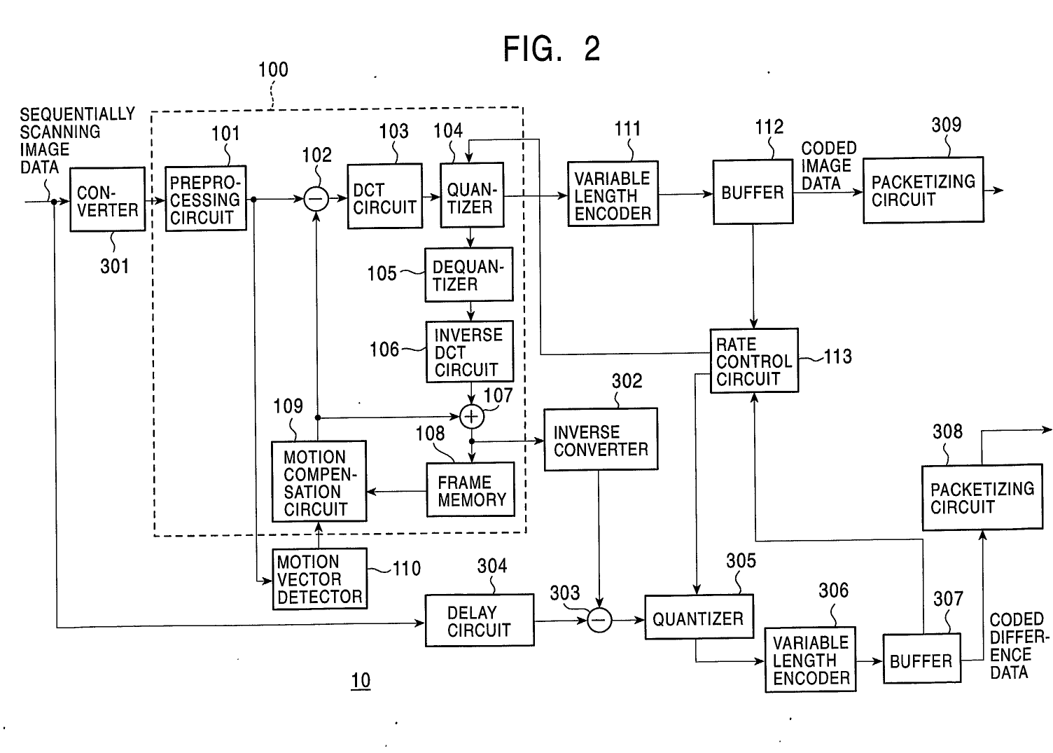

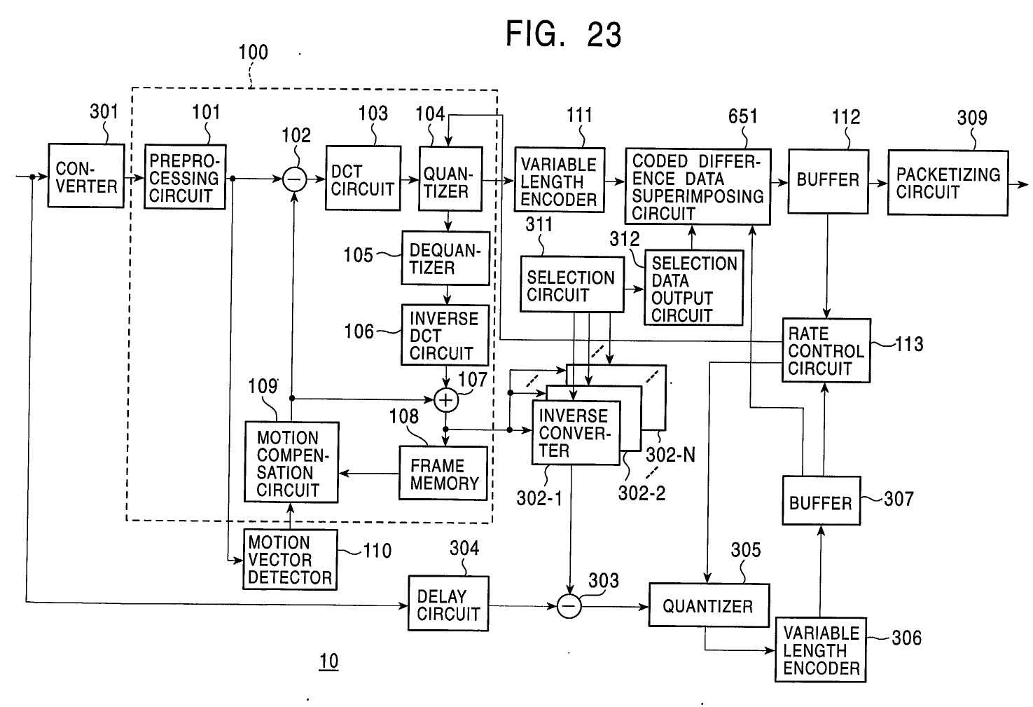

The image processing apparatus according to the first aspect of the invention comprises: producing means (for example, a converter 301 shown in FIG. 2) for producing second image data with a second frame rate by partially removing frames of first image data with a first frame rate; first encoding means (for example, an encoder 100 shown in FIG. 2) for encoding the second image data; interpolated frame producing means (for example, an inverse converter 302 shown in FIG. 2) for producing an interpolated frame from decoded image data obtained by decoding the second image data encoded by the first encoding means; calculating means (for example, a subtractor 303 shown in FIG. 23) for calculating the difference between the first image data and the decoded image data obtained by decoding the second image data on the basis of the interpolated frame produced by the interpolated frame producing means; and second encoding means (for example, a quantizer 305 shown in FIG. 2) for encoding the difference calculated by the calculating means.

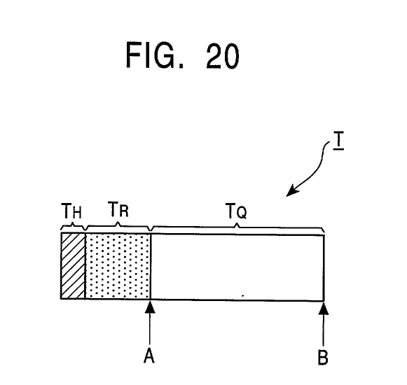

Preferably, the image processing apparatus further comprises superimposing means (for example, a coded difference data superimposing circuit 651 shown in FIG. 19) for superimposing the second image data encoded by the first encoding means and the difference encoded by the second encoding means.

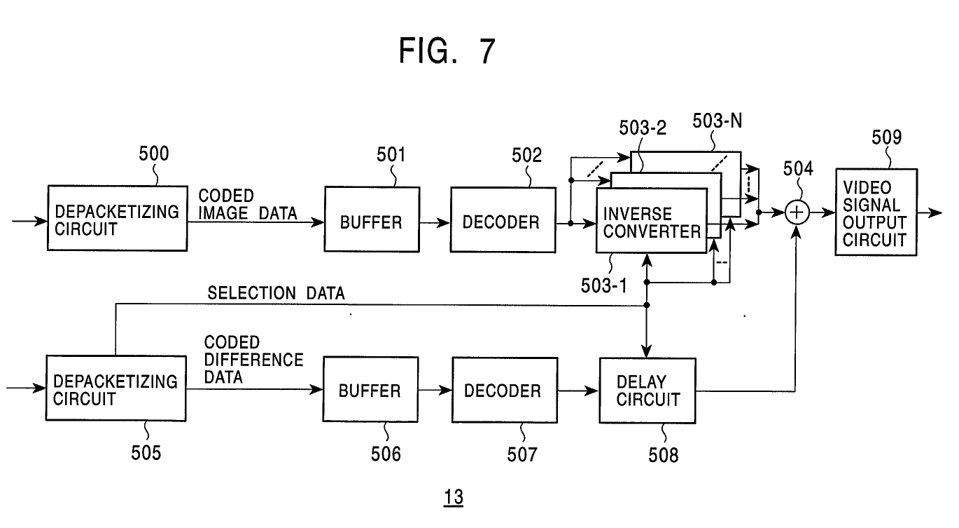

The image processing apparatus according to the fourth aspect of the invention comprises conversion means (for example, an inverse converter 503 shown in FIG. 7) for converting the frame rate of received coded image data, which has been transmitted at a predetermined frame rate, into its original frame rate; producing means (for example, a delay circuit 508 shown in FIG. 7) for producing difference data for use in decoding the coded image data; and decoding means (for example, an adder 504 shown in FIG. 7) for decoding the coded image data on the basis of the difference data produced by the producing means.

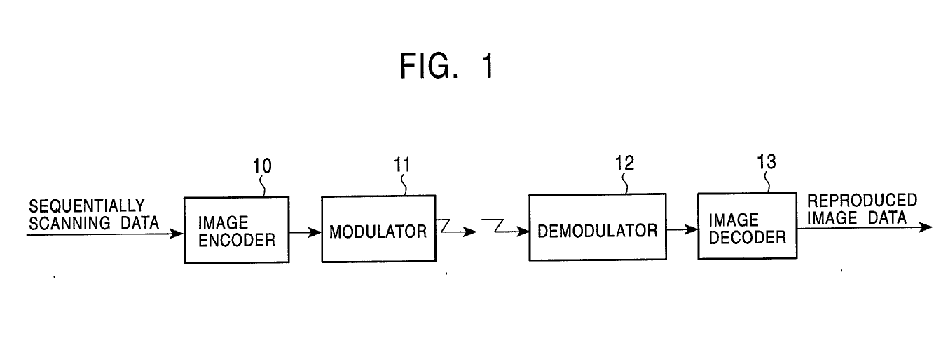

FIG. 1 illustrates an example of the construction of an image data communication system according to the present invention. In this image data communication system, sequentially scanning image data is input and processed, as described below. An image encoder 10 encodes input sequentially scanning image data in accordance with a predetermined encoding scheme thereby producing coded image data or coded difference data. The resultant data is output to a modulator 11. The modulator 11 multiplexes the coded image data or the coded difference data output from the image encoder 10 and modulates the multiplexed data. The resultant modulated signal is output over a predetermined transmission line. A demodulator 12 receives the modulated signal transmitted by the modulator 11 via the predetermined transmission line. The demodulator 12 demodulates the received signal thereby converting it into coded data. The resultant coded data is output to an image decoder 13. The image decoder 13 reproduces image data by decoding the coded data received from the demodulator 12 and supplies the reproduced image data to a display device (not shown).

FIG. 2 illustrates a first embodiment of the image encoder 10 according to the present invention. In FIG. 2, similar parts to those in FIG. 30 are denoted by similar reference numerals, and they are not described in further detail unless required.

Sequentially scanning image data is input to a converter 301 and also to a delay circuit 304. The converter 301 removes either odd-numbered or even-numbered frames from the sequentially scanning image data input to the converter 301 (hereinafter such a process will be referred to as a frame removing process), and the resultant data is output to a preprocessing circuit 101 of an encoder 100. As a result of the above process, the frame rate of the sequentially scanning data is converted from 60 to 30 frames/sec.

The adder 107 calculates the sum of data output from an inverse DCT circuit 106 and predicted image data output from the motion compensation circuit 109 thereby producing locally decoded image data, which is supplied to a frame memory 108 and an inverse converter 302.

The inverse converter 302 rearranges the sequence of frames, arranged in accordance with the picture type, of the locally decoded image data output from the adder 107 into a sequence of frames arranged in the same order as that in which the original image data was arranged before being encoded. The inverse converter 302 then calculates the mean value of image data of adjacent two frames (reference frames) of the rearranged sequence of frames thereby creating new frames (interpolated frames). The resultant interpolated frames are placed between the corresponding two reference frames. Hereinafter, the process of producing interpolated frames and inserting them into the image data will be referred to as frame interpolation. After completion of the frame interpolation, the inverse converter 302 outputs the resultant image data to a subtractor 303.

The delay circuit 304 delays the received sequentially scanning image data by an amount corresponding to the period of time required for the process performed by the converter 301, the encoder 100, and the inverse converter 302. The delayed sequentially scanning image data is output to the subtractor 303. The subtractor 303 calculates the difference between each frame of the frame-interpolated image data output from the inverse converter 302 and each corresponding frame of the sequentially scanning image data output from the delay circuit 304 after being delayed by the predetermined amount, thereby producing difference data. The resultant difference data is output to a quantizer 305.

According to a quantization step given by a rate control circuit 113, the quantizer 305 quantizes the difference data supplied from the subtractor 303 and outputs the resultant data to a variable length encoder 306. The variable length encoder 306 performs variable length encoding on the quantized data received from the quantizer 305 thereby generating coded difference data. The resultant coded difference data is output to buffer 307. The buffer 307 temporarily stores the coded difference data received from the variable length encoder 306 and sequentially outputs the coded difference data at a predetermined rate to a packetizing circuit 308. The packetizing circuit 308 packetizes the encoded difference data and outputs the resultant data to the modulator 11.

On the other hand, a packetizing circuit 309 receives encoded image data from a variable length encoder 111 via a buffer 112. The packetizing circuit 309 packetizes the received data and outputs the resultant data to the modulator 11. The rate control circuit 113 monitors the amount of coded image data stored in the buffer 112 and determines a quantization step depending on the amount of coded image data stored in the buffer 112. The rate control circuit 113 sends the resultant quantization step to a quantizer 104. The rate control circuit 113 also monitors the amount of coded image data stored in the buffer 307 and determines a quantization step depending on the amount of coded image data stored in the buffer 307. The resultant quantization step is sent to the quantizer 305.

The other parts are similar to those in FIG. 30.

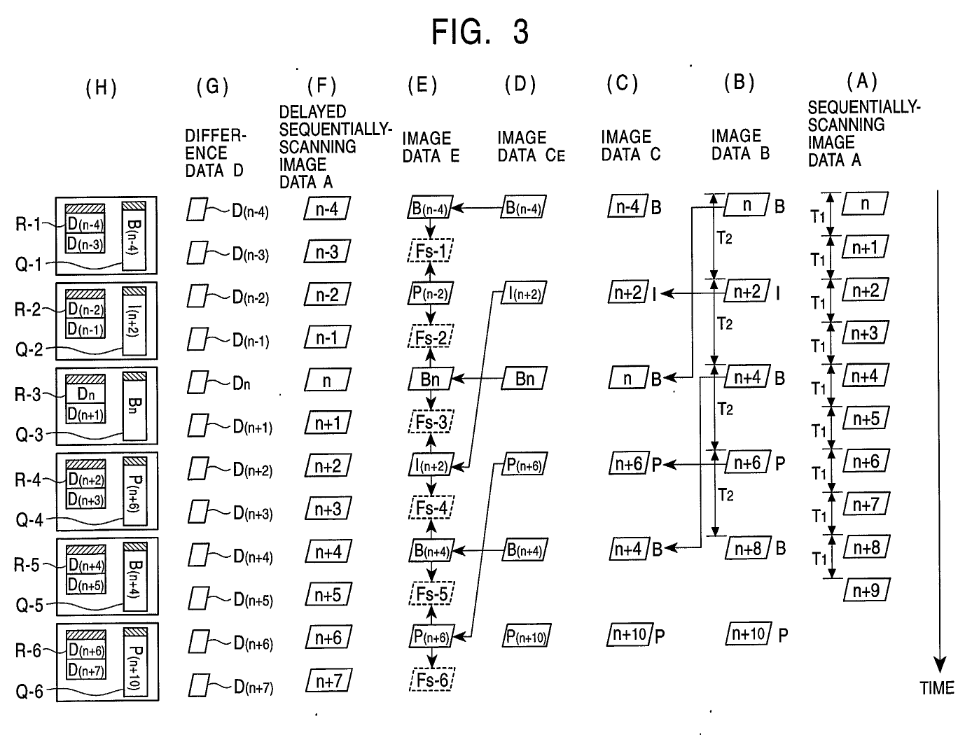

The operation of the image encoder 10 is described in further detail below, by way of example, for the case where nth to (n+9)th frames, shown in FIG. 3A, of sequentially scanning image data A to be transmitted at a rate of 60 frames/sec (at intervals of T1=1/600 sec) are encoded.

The converter 301 performs the frame removing process on the nth to (n+9)th frames of the sequentially scanning image data A. In this specific example, as shown in FIG. 3B, the (n+1)th, (n+3)th, (n+5)th, (n+7)th, and (n+9)th frames are removed. As a result of the frame removal, the frame rate of the sequentially scanning image data A is converted from 60 to 30 frames/sec. Herein, the sequentially scanning image data with the frame rate of 30 frames/sec obtained by performing the above conversion process on the sequentially scanning image data A is referred to as sequentially scanning image data B.

The preprocessing circuit 101 assigns a picture type to each frame of the image data B output from the converter 301 and rearranges the sequence of frames in accordance with the assigned picture type. More specifically, frames designated as I-picture or P-picture are maintained at the original locations, while frames which were designated as B-picture and which are prior in time to the frames designated as I-picture or P-picture are moved to locations following the frames designated as I-picture or P-picture. Hereinafter, the image data obtained by rearranging the frames of the image data B in such a manner will be referred to as image data C. In this specific example, as shown in FIG. 3C, the nth frame designated as a B-picture is moved to a location following the (n+2)th frame designated as an I-picture, and the (n+4)th frame designated as a B-picture is moved to a location following the (n+6)th frame designated as a P-picture.

The respective frames of the image data C output from the preprocessing circuit 101 are sequentially supplied to the prediction error generator 102. The prediction error generator 102 calculates the difference between the image data C and the predicted image data supplied from the motion compensation circuit 109 thereby generating prediction error data. The prediction error data output from the prediction error generator 102 is supplied to the DCT circuit 103 and converted to DCT coefficients. The resultant DCT coefficients are supplied to the quantizer 104.

According to the quantization step given by the rate control circuit 113, the quantizer 104 quantizes the DCT coefficients output from the DCT circuit 103. In this way, each frame of the image data C is quantized in accordance with its picture type.

The quantized data output from the quantizer 104 is supplied to the variable length encoder 111 and the dequantizer 105. The variable length encoder 111 performs variable length encoding on the quantized data received from the quantizer 104 thereby producing coded image data. The resultant coded image data is output to the buffer 112.

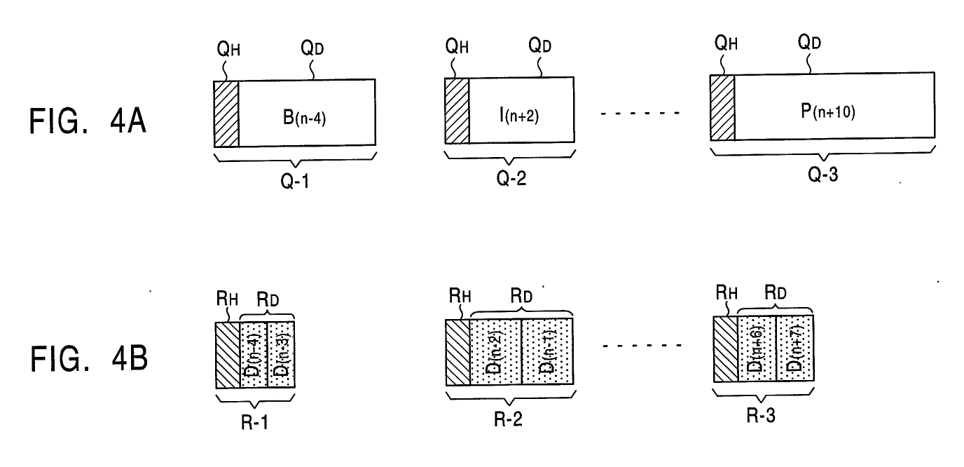

The coded image data produced by the variable length encoder 111 by encoding the image data C is then packetized by the packetizing circuit 309 at the following stage, as shown in FIG. 4A. Each coded image data packet Q consists of a header section QH and a coded image data section QD. The header section QH includes information indicating that the content of the packet is coded image data and also synchronization information required to transmit the packets Q in synchronization with coded difference data packets R such as those in shown in FIG. 4B. The coded image data section QD includes coded image data. The coded difference data packet R will be described in detail later.

As described above, the sequentially scanning image data input to the image encoder 10 is first changed in frame rate from 60 frames/sec to 30 frames/sec and then encoded. This allows a reduction in the amount of coded data.

On the other hand, the quantized data output from the quantizer 104 is supplied to a dequantizer 105 and dequantized. The dequantized data is supplied to the inverse DCT circuit 106 and subjected to an inverse DCT process. The data output from the inverse DCT circuit 106 is supplied to the adder 107 and added with the predicted image data output from the motion compensation circuit 109.

Via the above-described processes performed by the prediction error generator 102, the DCT circuit 103, and the quantizer 104, the quantized image data C is locally decoded, and image data CE is produced as shown in FIG. 3D. Herein, each frame of the produced image data CE has its own picture type designated earlier. The numerical subscript following each letter I, B, or P indicating the picture type represents the frame number.

The image data CE output from the adder 107 is supplied to a frame memory 108 and also to the inverse converter 302. The inverse converter 302 rearranges the sequence of frames of the received image data CE in accordance with the frame number as shown in FIG. 3E. After that, the inverse converter 302 calculates the mean value of images of adjacent two frames (reference frames) denoted by solid lines in FIG. 3E. The inverse converter 302 employs the calculation result as an interpolated frame FS and inserts it between the corresponding two reference frames, as represented by broken lines in FIG. 3E. Thus, the frame rate of the image data CE is converted from 30 frames/sec to 60 frames/sec by producing interpolated frames such as FS-1 to FS-6 and interposing them as described above. Hereinafter, the image data obtained by converting the frame rate of the image data CE to 60 frames/sec will be referred to as image data E.

The delay circuit 304 delays the sequentially scanning image data A shown in FIG. 3A by an amount corresponding to the period of time required for the processes performed by the converter 301, the encoder 100, and inverse converter 302. The delayed sequentially scanning image data is output to the subtractor 303. The subtractor 303 calculates the difference between each frame of the image data E, such as that shown in FIG. 3E, output from the inverse converter 302 and each frame, corresponding to the frame number of the image data E, of the delayed sequentially scanning data A, such as that shown in FIG. 3F, output from the delay circuit 304, thereby generating difference data D as shown in FIG. 3G. The difference data D is sequentially output to the quantizer 305.

The quantizer 305 quantizes the difference data D received from the subtractor 303 and outputs the resultant data to the variable length encoder 306. The variable length encoder 306 performs variable length encoding on the difference data D received from the quantizer 305 thereby generating coded difference data. The resultant coded difference data is output to the buffer 307.

The coded difference data D output from the variable length encoder 306 is then packetized by the packetizing circuit 308, as shown in FIG. 4B. The coded difference data packet R consists of a header section RH and a coded difference data section RD. The coded difference data section RD includes two pieces of coded difference data associated with reference frames of the image data E shown in FIG. 3E (frames denoted by solid lines) or associated with following interpolated frames FS. For example, a coded difference data packet R-1 includes (n−4)th coded difference data D(n-4) shown in FIG. 3G (difference data representing the difference between the image data B(n-4) shown in FIG. 3(E) and the image data (n-4) shown in FIG. 3F) and also includes (n−3)th coded difference data D(n-3) shown in FIG. 3G (difference data representing the difference between the interpolated image data FS-1 shown in FIG. 3E and the image data (n-3) shown in FIG. 3F). On the other hand, a coded difference data packet R-2 includes (n−2)th coded difference data D(n-2) shown in FIG. 3G (difference data representing the difference between the image data P(n-2) shown in FIG. 3(E) and the image data (n-2) shown in FIG. 3F) and also includes (n−1)th coded difference data D(n-1) shown in FIG. 3G (difference data representing the difference between the interpolated image data FS-2 shown in FIG. 3E and the image data (n-1) shown in FIG. 3F).

The header RH includes information indicating that the content of the packet is coded image data and also synchronization information required to transmit the packets R in synchronization with the corresponding coded image data packets Q.

For example, as shown in FIG. 3H, a coded image data packet Q-2 including coded image data I(n+2) of the (n+2)th frame of the image data C shown in FIG. 3C is output in synchronization with a coded difference data packet R-2 including the (n−2)th coded difference data D(n-2) and the (n−1)th coded difference data D(n-1). Similarly, a coded image data packet Q-4 including coded image data P(n+6) of the (n+6)th frame of the image data C is output in synchronization with a coded difference data packet R-4 including the (n+2)th coded difference data D(n+2) and the (n+3)th coded difference data D(n+3).

As described above, each frame of the coded difference data transmitted at the rate of 60 frames/sec is output to the modulator 11 in synchronization with each corresponding frame of the coded image data transmitted at the rate of 30 frames/sec.

The quantizer 305 has similar functions and performance to those of the quantizer 104, and the variable length encoder 306 has similar functions and performance to those of the variable length encoder 111.

Because the coded difference data is output at a rate lower than the rate at which the coded image data is output, the processing speed of the buffer 307 is allowed to be set to a lower value than the processing speed at which the buffer 112 buffers the coded image data. The variable length encoder 111 and the buffer 112 of the image encoder 10 shown in FIG. 2 are not concerned with the process associated with difference data. This allows the processing speeds of these circuit elements to be set to lower values than required in the image encoder 1 shown in FIG. 30.

In the embodiment described above, differences are determined between all frames (all reference frames and interpolated frames FS) of the image data E shown in FIG. 3E and corresponding frames of the sequentially scanning image data A shown in FIG. 3F. However, in most cases, the differences between the reference frames (frames other than the interpolated frames FS) shown in FIG. 3E and the corresponding frames of the sequentially scanning image data A shown in FIG. 3F are small. Thus, the differences associated with those frames may be set to zero. That is, in this specific example, of the difference data D shown in FIG. 3G, the (n−4)th, (n−2)th, nth, (n+2)th, (n+4)th, and (n+6)th difference data D may be set to zero. This allows a further reduction in the amount of coded data.

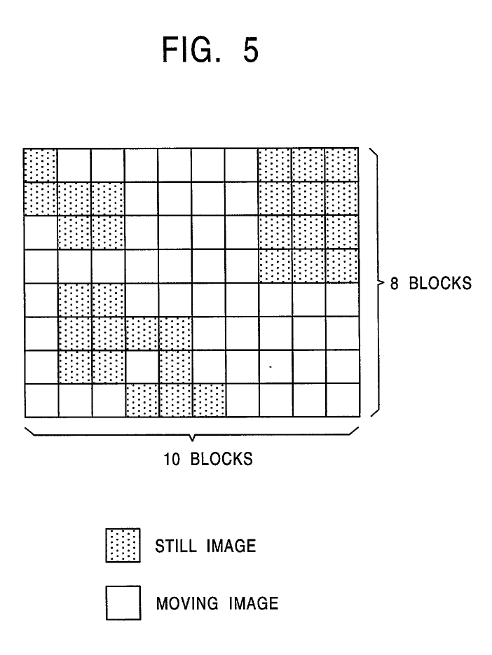

Furthermore, when image data consisting of 10×8 macro blocks such as that shown in FIG. 5 is given, if the difference data associated with macro blocks associated with still images denoted by means of shading in FIG. 5 is set to zero, a further reduction in the amount of coded data can be achieved.

In the case where image data is encoded for a plurality of channels, there may be provided as many image encoders 10 as there are channels.

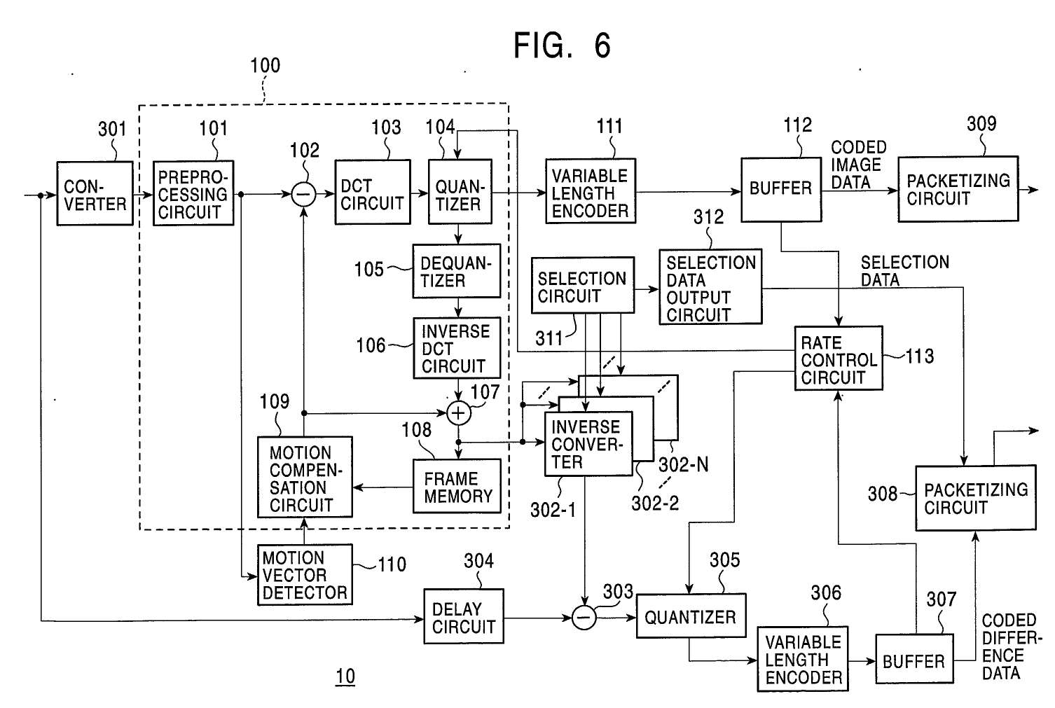

FIG. 6 illustrates a second embodiment of the image encoder 10 according the present invention. In FIG. 6, similar parts to those in FIG. 2 are denoted by similar reference numerals. In this second embodiment of the image encoder 10, the inverse converter 302 consists of N inverse converters 302-1 to 302-N (hereinafter, they will be generically referred to as the inverse converter 302 when there is no need to identify individual inverse converters). Furthermore, a selection circuit 311 and a selection data output circuit 312 are disposed at stages following the inverse converter 302. The other parts are similar to those in FIG. 2, and they are not described in further detail.

The inverse converters 302-1 to 302-N rearrange the sequence of frames, arranged in accordance with the picture type, of the locally decoded image data output from the adder 107 into a sequence of frames arranged in the same order as that in which the original image data was arranged before being encoded. After that, the inverse converters 302-1 to 302-N perform frame interpolation in manners different from each other. The selection circuit 311 selects one of the inverse converters 302-1 to 302-N. That is, one inverse converter 302-i (i=1, 2, . . . , N) selected by the selection circuit 311 performs the frame rearrangement and the frame interpolation in a particular manner assigned to the inverse converter 302-i.

The selection circuit 311 sends identification information (i) of the selected inverse converter 302-i to the selection data output circuit 312. The selection data output circuit 312 transfers the identification information of the inverse converter 302-i received from the selection circuit 311 to the packetizing circuit 308. The packetizing circuit 308 adds the received identification information to the header of the coded difference data and outputs the resultant coded difference data to the modulator 11.

In this embodiment, as described above, frame interpolation can be performed in different manners.

Referring now to FIG. 7, a first embodiment of the image decoder 13 corresponding to the second embodiment of the image encoder 10 is described below, wherein the operation of processing the coded image data, the selection data, and the coded difference data, received via the modulator 11 and the demodulator 12 from the image encoder 10 according to the second embodiment is also described.

Coded image data, which has been encoded by the image encoder 10 shown in FIG. 6 and transmitted at a frame rate of 30 frames/sec, is depacketized by a depacketizing circuit 500 and input to a buffer 501. On the other hand, coded difference data which has been transmitted at a frame rate of 60 frames/sec is depacketized by a depacketizing circuit 505 and input to a buffer 506. Selection data indicating the inverse converter 302-i, shown in FIG. 6, selected in the encoding process is extracted from the header by the depacketizing circuit 505 and input to N inverse converters 503-1 to 503-N and also to a delay circuit 508.

The buffer 501 temporarily stores the coded image data input to the buffer 501 and outputs it at a predetermined rate to a decoder 502. The decoder 502 includes a variable length decoder, a dequantizer, an inverse DCT circuit, and a motion compensation predicting circuit and serves to decode the coded image data supplied from the buffer 501. The resultant decoded image data is output to the inverse converters 503-1 to 503-N.

Each of the inverse converters 503-1 to 503-N rearranges the sequence of frames, arranged in the order of the picture type, of the image data output from the decoder 502 into a sequence of frames arranged in the same order as that in which the original image data was arranged before being encoded. Each of the inverse converters 503-1 to 503-N is designed to perform frame interpolation in the same manner as that employed by the corresponding inverse converter 302-1 to 302-N shown in FIG. 6. In practical operation, one inverse converter 503-i designated by the selection data is selected from the inverse converters 503-1 to 503-N and the selected inverse converter 503-i performs the above-described process. Thus, the frame rate of the sequentially scanning image data transmitted at the frame rate of 30 frames/sec is converted (inversely converted) to the original value of 60 frames/sec.

The buffer 506 temporarily stores the coded difference data input to the buffer 506 and outputs it at a predetermined rate to a decoder 507. The decoder 507 includes a variable length decoder, a dequantizer, an inverse DCT circuit, and a motion compensation predicting circuit, which are not shown in FIG. 7. The decoder 507 decodes the coded difference data supplied from the buffer 506 and outputs the resultant decoded difference data to a delay circuit 508.

The delay circuit 508 delays the image data received from the decoder 507 by an amount corresponding to the period of time required for the process performed by the inverse converter 503-i corresponding to the given selection data. The delayed image data is output to an adder 504.

The adder 504 calculates the sum of the image data output from the inverse converter 503-i and the image data output from the delay circuit 508 thereby producing locally decoded image data. The resultant data is output to a video signal output circuit 509. The video signal output circuit 509 performs a predetermined process on the locally decoded image data output from the adder 504 so as to reproduce an image and outputs the result to a display device (not shown).

Thus, as described above, the coded image data of the sequentially scanning image data which was encoded by the image encoder 10 shown in FIG. 6 and transmitted at the frame rate of 30 frames/sec is decoded on the basis of the coded difference data transmitted at the frame rate of 60 frames/sec.

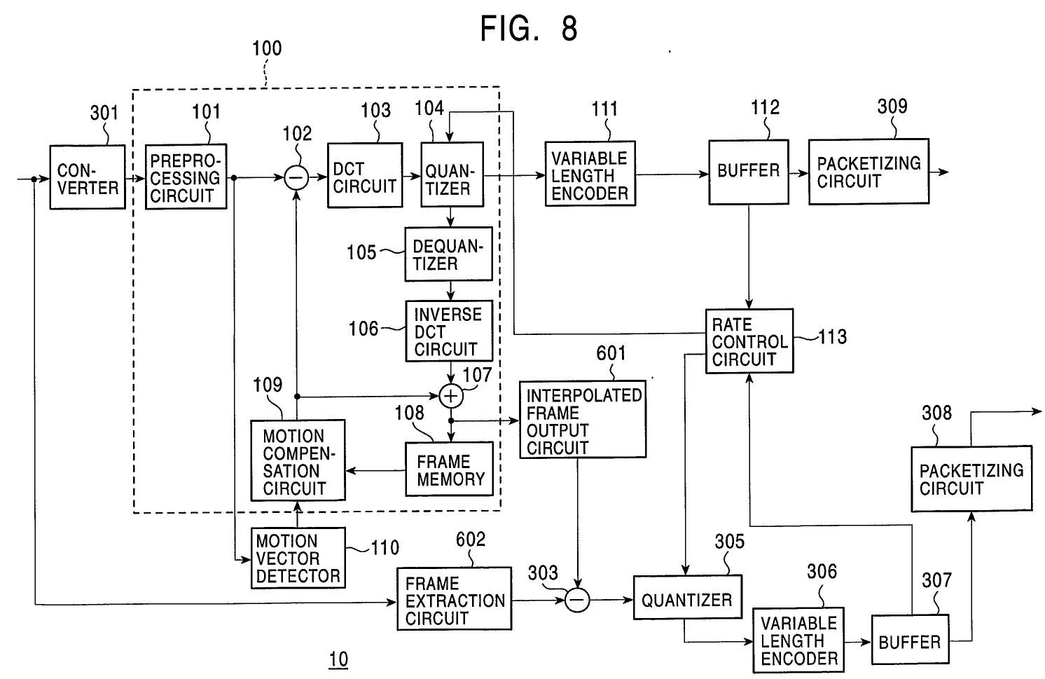

FIG. 8 illustrates a third embodiment of the image encoder 10 according to the present invention. In FIG. 8, similar parts to those in FIG. 2 are denoted by similar reference numerals. In this image encoder 10, the inverse converter 302 is replaced with an interpolated frame output circuit 601, and the delay circuit 304 is replaced with a frame extraction circuit 602. The other parts are similar to those in FIG. 2.

The adder 107 calculates the sum of data output from the inverse DCT circuit 106 and predicted image data output from the motion compensation circuit 109 thereby producing locally decoded image data, which is supplied to the frame memory 108 and the inverse converter 601.

The interpolated frame output circuit 601 rearranges the sequence of frames, arranged in the order of the picture type, of the locally decoded image data output from the adder 107 into a sequence of frames arranged in the same order as that in which the original image data was arranged before being encoded. The interpolated frame output circuit 601 produces an interpolated frame by averaging images of two adjacent reference frames and outputs only the interpolated frame to a subtractor 303. Hereinafter, the process of producing such interpolated frames and outputting only the resultant interpolated frames will be referred to as an interpolated frame outputting process.

The frame extraction circuit 602 extracts, from the input sequentially scanning image data, such frames having the same phase as that of the interpolated frames output from the interpolated frame output circuit 601. The frame extraction circuit 602 delays the extracted frames by an amount corresponding to the period of type required for the process performed by the respective circuit elements of the encoder 100, the motion vector detector 110, and the interpolated frame output circuit 601. The extracted and delayed frames are output to the subtractor 303.

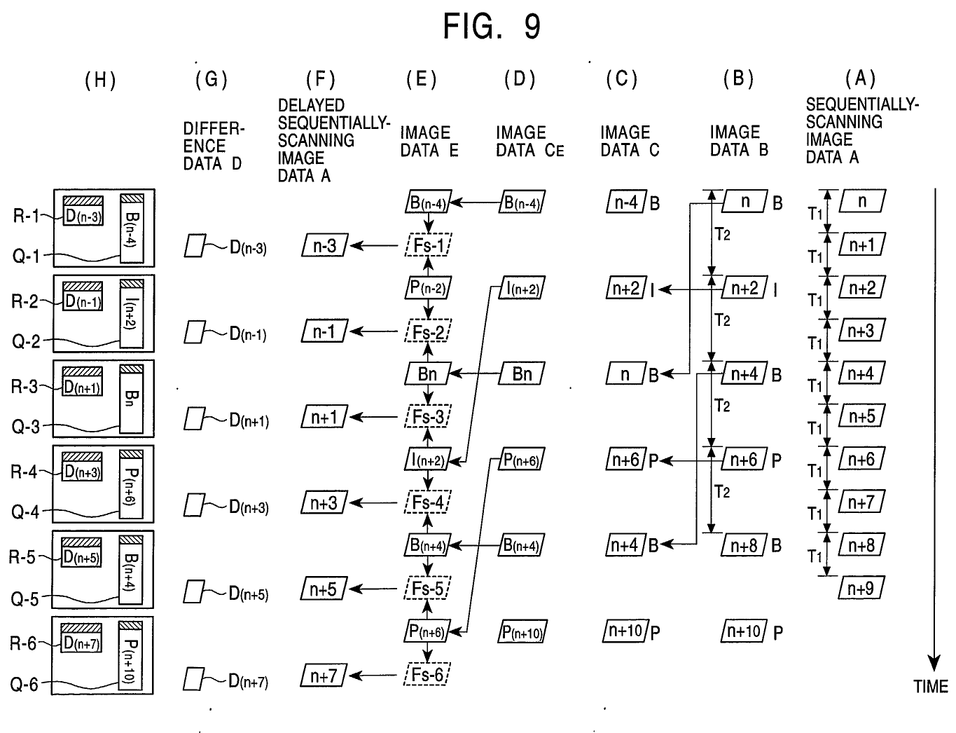

The operation of the third embodiment of the image encoder 10 is described below, by way of example, for the case where nth to (n+9)th frames of the sequentially image data A shown in FIG. 9A are encoded.

FIG. 9A shows the nth to (n+9)th frames of the sequentially scanning image data A corresponding to those shown in FIG. 3A. Each image data shown in FIGS. 9B to 9D corresponds to image data shown in FIGS. 3B to 3D, respectively. These frames of image data are produced via a process similar to that employed in the first embodiment of the image encoder 10 shown in FIG. 2. That is, when sequentially scanning image data A (FIG. 9A) to be transmitted at a rate of 60 frames/sec is input to a converter 301, the converter 301 partially removes frames from the received sequentially scanning image data A as shown FIG. 9B. After that, the preprocessing circuit 101 rearranges the sequence of frames in accordance with the picture type as shown in FIG. 9C. After the frame rearrangement by the preprocessing circuit 101, the image data (image data C) is quantized via the prediction error generator 102, the motion vector detector 110, the quantizer 104, and the adder 107 and output to the variable length encoder 111. The image data (image data C) is also locally decoded as shown in FIG. 9D and output to the interpolated frame output circuit 601.

The variable length encoder 111 produces coded image data by performing variable length encoding on the quantized data received from the quantizer 104. The resultant coded image data is output to the modulator 11 via the buffer 112 and the packetizing circuit 309.

The interpolated frame output circuit 601 rearranges the sequence of frames, arranged in the order of the picture type, of the image data CE shown in FIG. 9D output from the adder 107 into a sequence of frames arranged in the same order as that in which the original image data was arranged before being encoded as shown in FIG. 9E. After that, the interpolated frame output circuit 601 calculates mean values of respective two adjacent reference frames represented by solid lines in FIG. 9 thereby producing interpolated frames FS as represented by broken lines in FIG. 9 and outputs only the interpolated frames FS to the subtractor 303.

As shown in FIG. 9F, the frame extraction circuit 602 extracts, from the input sequentially scanning image data A, such frames having the same phase as that of the interpolated frames FS output from the interpolated frame output circuit 601. The frame extraction circuit 602 then delays the extracted frames by an amount corresponding to the period of type required for the process performed by the respective circuit elements of the encoder 100, the motion vector detector 110, and the interpolated frame output circuit 601. The extracted and delayed frames are output to the subtractor 303 in synchronization with the respective interpolated frames FS.

The subtractor 303 calculates the difference between the interpolated frames FS output from the interpolated frame output circuit 601 and the corresponding frames output from the frame extraction circuit 602 thereby producing difference data D as shown in FIG. 9G. The resultant difference data D is output to the quantizer 305.

The quantizer 305 produces quantized data by quantizing the difference data D received from the adder 303. The quantized data output from the quantizer 305 is supplied to the variable length encoder 306. The variable length encoder 306 performs variable length encoding on the received quantized data thereby producing coded difference data. The resultant coded difference data is output to the modulator 11 via the buffer 307 and the packetizing circuit 308.

Because only the difference data D between the interpolated frames FS and the corresponding frames of the sequentially scanning image data A is encoded as described above, the amount of coded data can be further reduced compared with the first or second embodiment in which all difference data D is encoded by the image encoder 10. Thus, the coded difference data is output at a frame rate of 30 from the buffer 307.

The coded image data and the coded difference data produced in the above-described manner are packetized by the packetizing circuits 309 and 308, respectively, into a coded image data packet Q and a coded difference data packet R, respectively, as shown in FIG. 4 and output to the modulator 11. In this process, a coded image data packet Q-2 obtained by packetizing the coded image data I(n+2) of the (n+1)th frame of the image data C shown in FIG. 9C is output in synchronization with a coded difference data packet R-2, shown in FIG. 9H, obtained by packetizing the coded difference data of the (n−1)th difference data D(n-1) shown in FIG. 9G. Similarly, a coded image data packet Q-4 obtained by packetizing the coded image data P(n+6) of the (n+6)th frame of the image data C is output in synchronization with a coded difference data packet R-4 obtained by packetizing the coded difference data of the (n+3)th difference data D(n+3).

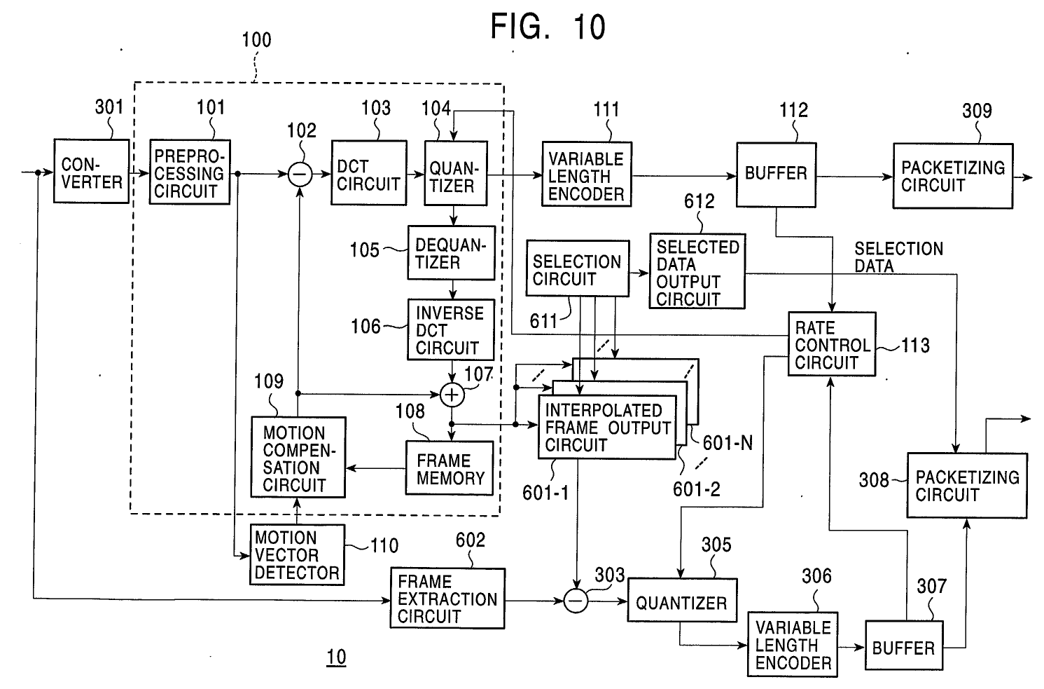

FIG. 10 illustrates a fourth embodiment of the image encoder 10 according the present invention. In FIG. 10, similar parts to those in FIG. 8 are denoted by similar reference numerals. This image encoder 10 includes an interpolated frame output circuit 601 consisting of N interpolated frame output circuits 601-1 to 601-N. Furthermore, a selection circuit 611 and a selection data output circuit 612 are disposed at stages following the interpolated frame output circuit 601. The other parts are similar to those in FIG. 8.

The interpolated frame output circuits 601-1 to 601-N rearrange the sequence of frames, arranged in accordance with the picture type, of the locally decoded image data output from the adder 107 into a sequence of frames arranged in the same order as that in which the original image data was arranged before being encoded. After that, the interpolated frame output circuits 601-1 to 601-N perform frame interpolation in manners different from each other. The selection circuit 611 selects one of the interpolated frame output circuits 601-1 to 601-N so that the one interpolated frame output circuit 601-i selected by the selection circuit 611 performs an interpolated frame output process including the frame rearrangement and the frame interpolation in a particular manner assigned to the selected interpolated frame output circuit 601-i and outputs the resultant data.

The selection circuit 611 sends identification information (i) of the selected interpolated frame output circuit 601-i to the selection data output circuit 612. The selection data output circuit 612 transfers the identification information of the selected interpolated frame output circuit 601-i received from the selection circuit 611 to the packetizing circuit 308. The packetizing circuit 308 adds the received identification information to the header of the packet of the coded difference data and outputs the resultant packet to the modulator 11.

In this embodiment, as described above, the interpolated frame outputting process can be performed in different manners.

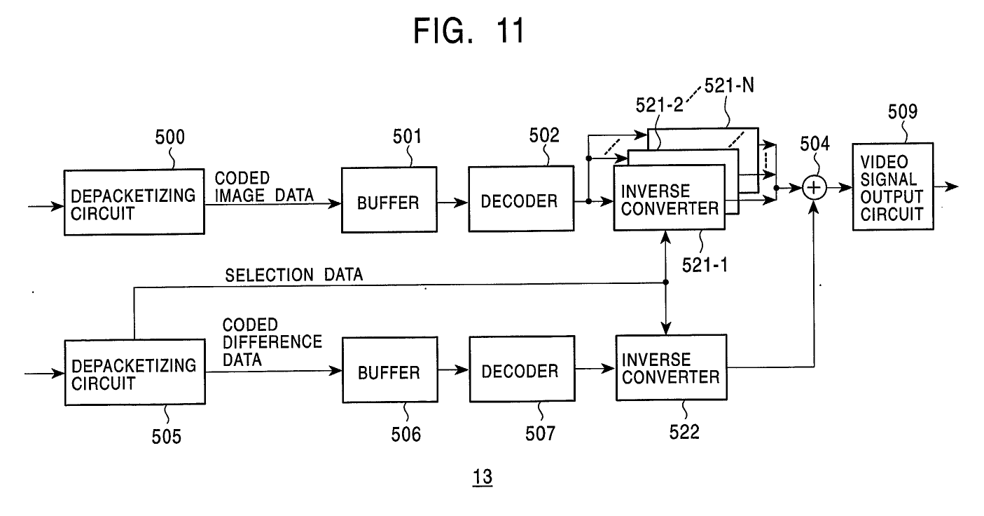

Referring now to FIG. 11, a second embodiment of the image decoder 13 corresponding to the fourth embodiment of the image encoder 10 is described below, wherein the operation of processing the coded image data, the selection data, and the coded difference data, received via the modulator 11 and the demodulator 12 from the image encoder 10 according to the fourth embodiment is also described. In FIG. 11, similar parts to those in FIG. 7 are denoted by similar reference numerals. In this image encoder 10, N inverse converters 503-1 to 503-N are replaced with N inverse converters 521-1 to 521-N, and the delay circuit 508 is replaced with an inverse converter 522. The other parts are similar to those in FIG. 7, and they are not described in further detail.

Coded image data, which has been encoded by the image encoder 10 shown in FIG. 10 and transmitted at a frame rate of 30 frames/sec, is depacketized by the depacketizing circuit 500 and input to the buffer 501. On the other hand, coded difference data which has been transmitted at a frame rate of 30 frames/sec is depacketized by the depacketizing circuit 505 and input to the buffer 506. Selection data indicating the interpolated frame output circuit 601-i shown in FIG. 10 selected in the encoding process is extracted from the header by the depacketizing circuit 505 and input to N inverse converters 521-1 to 521-N and also to the inverse converter 522.

Each of the inverse converters 521-1 to 521-N rearranges the sequence of frames, arranged in accordance with the picture type, of the image data output from the decoder 502 into a sequence of frames arranged in the same order as that in which the original image data was arranged before being encoded. The inverse converters 521-1 to 521-N are designed to produce interpolated frames in the same manner as that employed by the corresponding interpolated frame output circuits 601-1 to 601-N shown in FIG. 10. In practical operation, one inverse converter 521-i designated by the selection data is selected from the inverse converters 521-1 to 521-N and the selected inverse converter 521-i performs the above-described process. Thus, the frame rate of the sequentially scanning image data transmitted at 30 frames/sec is converted (inversely converted) to the original value of 60 frames/sec.

The inverse converter 522 performs frame interpolation upon the difference data output from the decoder 507 thereby converting the frame rate of the difference data from 30 to 60 frames/sec.

The adder 504 calculates the sum of the image data output at the rate of 60 frames/sec from the inverse converter 521-i and the difference data output at the rate of 60 frames/sec from the inverse converter 522 thereby producing locally decoded image data, which is supplied to the video signal output circuit 509. The video signal output circuit 509 performs a predetermined process on the locally decoded image data output from the adder 504 so as to reproduce an image and outputs the result to a display device (not shown).

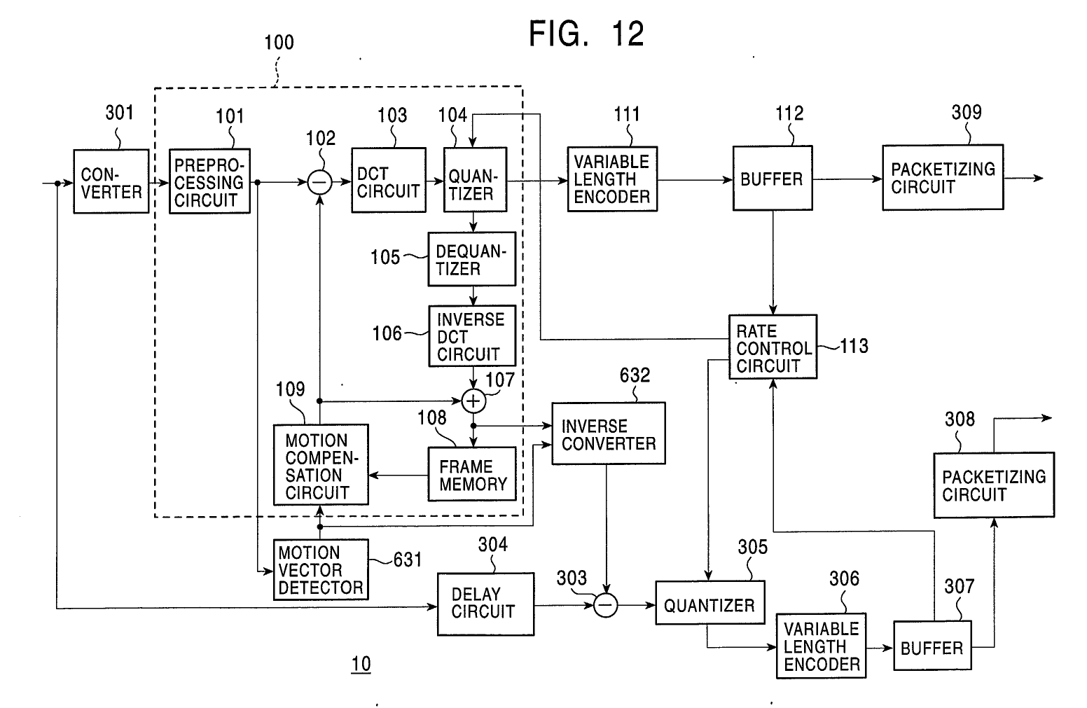

FIG. 12 illustrates a fifth embodiment of the image encoder 10 according to the present invention. In FIG. 12, similar parts to those in FIG. 2 are denoted by similar reference numerals. In this image encoder 10, the motion vector detector 110 is replaced with a motion vector detector 631, and the inverse converter 302 is replaced with an inverse converter 632. The other parts are similar to those in FIG. 2.

The motion vector detector 631 calculates a motion vector from the image data supplied from the preprocessing circuit 101 and outputs resultant data to the motion compensation circuit 109 and also to the inverse converter 632.

The inverse converter 632 rearranges the sequence of frames, arranged in accordance with the picture type, of the locally decoded image data output from the adder 107 into a sequence of frames arranged in the same order as that in which the original image data was arranged before being encoded. After that, the inverse converter 632 performs frame interpolation. That is, the inverse converter 632 produces interpolated frames on the basis of the motion vectors output from the motion vector detector 631.

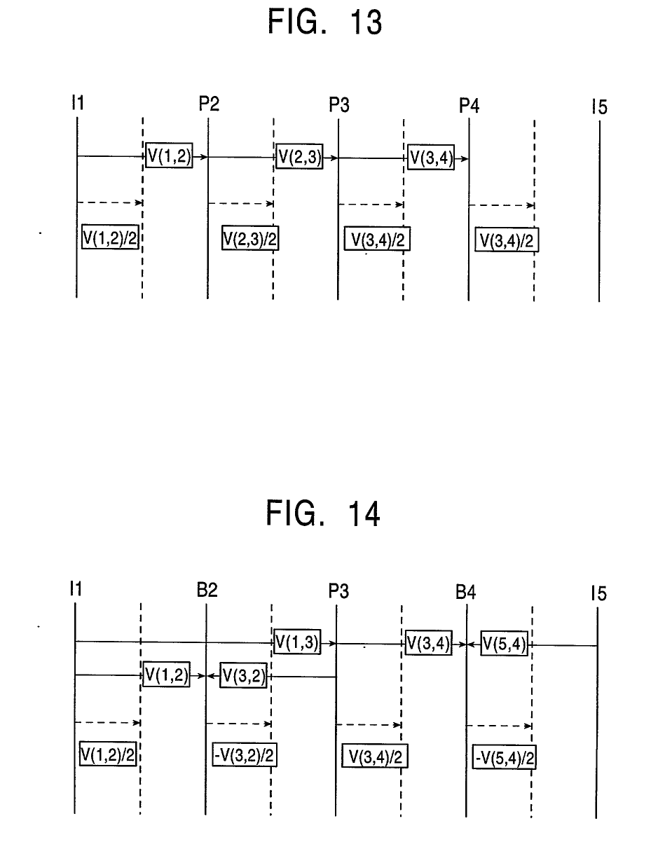

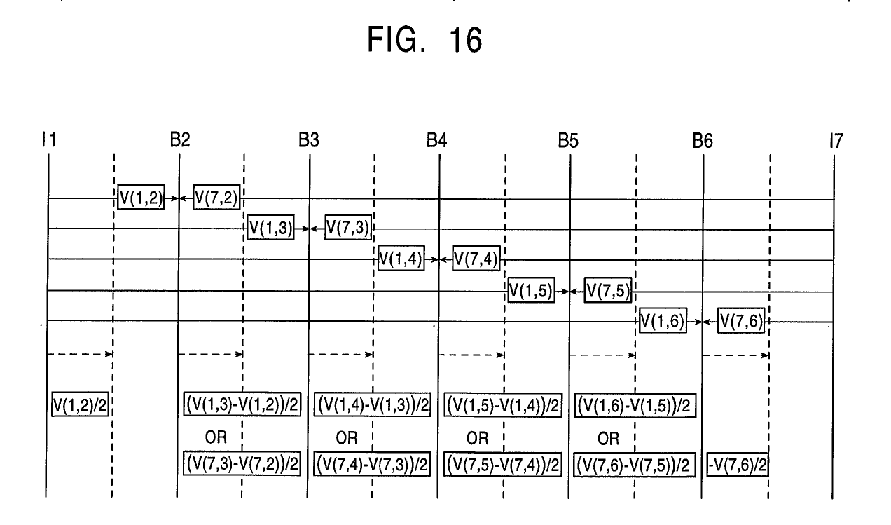

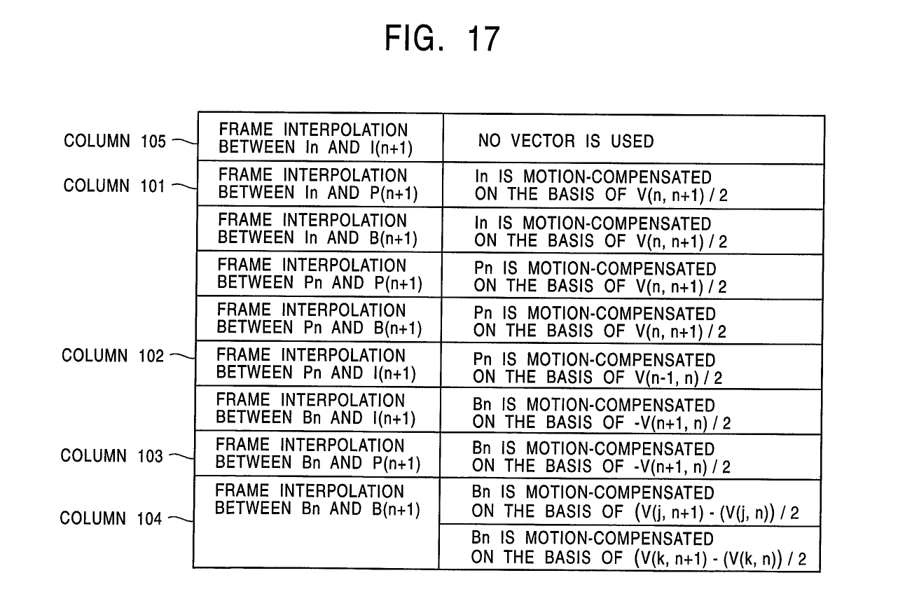

Referring now to FIGS. 13 to 17, the frame interpolation performed by the fifth embodiment of the image encoder 10 according to the invention is described below. FIG. 13 illustrates examples of interpolated frames produced by the inverse converter 632. The motion vector detector 631 detects a motion vector V(1, 2) representing the motion from an I-picture I1 to a P-picture P2, a motion vector V(2, 3) representing the motion from the P-picture P2 to a Ppicture P3, and a motion vector V(3, 4) representing the motion from the P-picture to a P-picture P4, as represented by solid-line arrows in FIG. 13. The resultant motion vectors are supplied to the inverse converter 632. On the basis of the received motion vectors, the inverse converter 632 produces interpolated frames.

More specifically, an interpolated frame at a location, for example, between the I-picture I1 and the P-picture P2 is produced by determining a motion vector representing the motion from the I-picture I1 to the interpolated frame and then performing motion compensation on the I-picture I1 in accordance with the obtained motion vector. The interpolated frame is different from the I-picture I1 by an amount corresponding to one-half a frame. Therefore, the motion vector representing the motion from the I-picture I1 to the interpolated frame can be given as V(1, 2)/2 which is obtained by multiplying the motion vector V(1, 2) representing the motion from the I-picture I1 to the Ppicture P2 by a weighting factor of ½. Thus, the interpolated frame can be produced by performing motion compensation upon the image data of the I-picture I1 in accordance with the motion vector V(1, 2)/2. More generally, an interpolated frame located between an I-picture In and a P-picture P(n+1) immediately following the I-picture In is produced, as shown in column 101 in FIG. 17, by performing motion compensation upon the image data of the I-picture in accordance with a motion vector V(n, n+1)/2, as shown in column 101 in FIG. 17.

On the other hand, an interpolated frame at a location, for example, between a P-picture P4 and an I-picture I5 is produced by performing motion compensation upon the P-picture P4 in accordance with a motion vector representing the motion from the P-picture P4 to the interpolated frame wherein the motion vector representing the motion from the P-picture P4 to the interpolated frame is given as V(3, 4)/2 by multiplying the motion vector V(3, 4) representing the motion from the P-picture P3 to the P-picture P4 by a weighting factor of ½. More generally, an interpolation frame between a P-picture Pn and an I-picture I(n+1) immediately following the P-picture Pn is produced by performing motion compensation upon the P-picture Pn in accordance with a motion vector V(n-1, n)/2 obtained by multiplying the motion vector V(n-1, n) representing the motion from a P-picture Pn-1 immediately preceding the P-picture Pn to the P-picture Pn by a weighting factor of ½, as shown in column 102 in FIG. 17. As described above, interpolated frames are produced using motion vectors which are produced in different manners depending on the picture type of reference frames.

FIG. 14 illustrates another example of the manner in which interpolated frames are produced by the inverse converter 632. An interpolated frame at a location, for example, between a B-picture B2 and a P-picture P3 is produced by performing motion compensation upon the B-picture B2 in accordance with a motion vector representing the motion from the B-picture B2 to the interpolated frame wherein the motion vector representing the motion from the B-picture B2 to the interpolated frame is given as −V(3, 2)/2 by multiplying the motion vector V(3, 2) representing the motion from the P-picture P3 to the B-picture B2 by a weighting factor of −½. More generally, an interpolation frame between a B-picture Bn and a P-picture P(n+1) immediately following the B-picture Bn is produced by performing motion compensation upon the B-picture Bn in accordance with a motion vector −V(n+1, n)/2 obtained by multiplying the motion vector V(n+1, n) representing the motion from the P-picture P(n+1) to the B-picture Bn by a weighting factor of −½, as shown in column 103 in FIG. 17. Herein, a motion vector representing a motion in an opposite direction in terms of time is represented by adding a negative sign to the motion vector V(n+1, n).

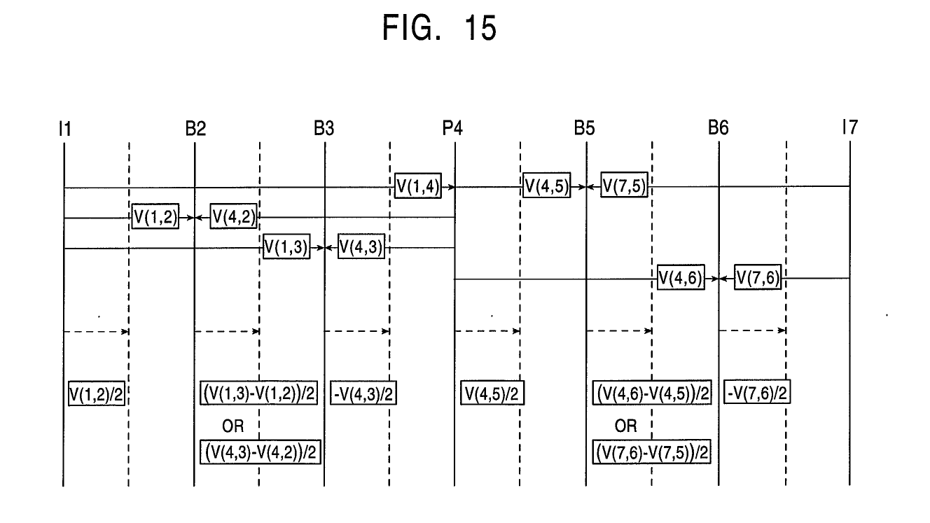

FIG. 15 illustrates still another example of the manner in which interpolated frames are produced by the inverse converter 632. An interpolated frame at a location, for example, between a B-picture B5 and a B-picture P6 is produced by performing motion compensation upon the B-picture B5 in accordance with a motion vector representing the motion from the B-picture B5 to the interpolated frame wherein the motion vector from the B-picture B5 to the interpolated frame is given according to equation (1) or (2) shown below:

(V(4, 6)−V(4, 5))/2 (1)

(V(7, 6)−V(7, 5))/2 (2)

More generally, an interpolated frame at a location between a B-picture Bn and an immediately following B-picture B(n+1) is produced by performing motion compensation upon the B-picture Bn in accordance with a motion vector given by equation (3) or (4), as shown in column 104 in FIG. 17.

(V(j, n+1)−V(j, n))/2 (3)

(V(k, n+1)−V(k, n))/2 (4)

In equation (3), V(j, n+1) denotes a motion vector representing the motion from an I-picture or P-picture, which is contained in a sequence of frames preceding the B-picture Bn and which is closest to the B-picture Bn, to a B-picture B(n+1), and V(j, n) denotes a motion vector representing the motion from that I-picture or P-picture to the B-picture Bn. In equation (4), V(k, n+1) denotes a motion vector representing the motion from an I-picture or P-picture, which is contained in a sequence of frames following the B-picture B(n+1) and which is closest to the B-picture B(n+1), to the B-picture B(n+1), and V(k, n) denotes a motion vector representing the motion from that I-picture or P-picture to the B-picture Bn.

In addition to the manner of producing interpolated frames between the pictures of the above-described types, the manner of producing interpolated frames between other types of pictures (between In and B(n+1), between Pn and P(n+1), between Pn and B(n+1), and between Bn and I(n+1)) is also shown in FIG. 17. As shown in column 105 in FIG. 17, no motion vector is used when an interpolated frame is produced between two I-pictures.

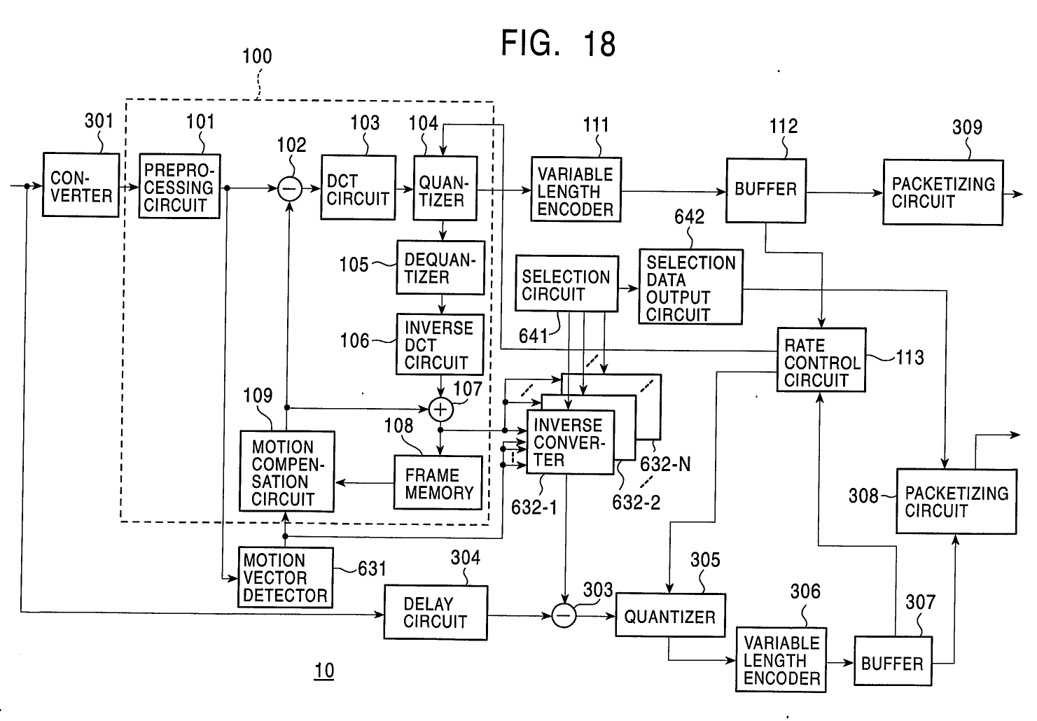

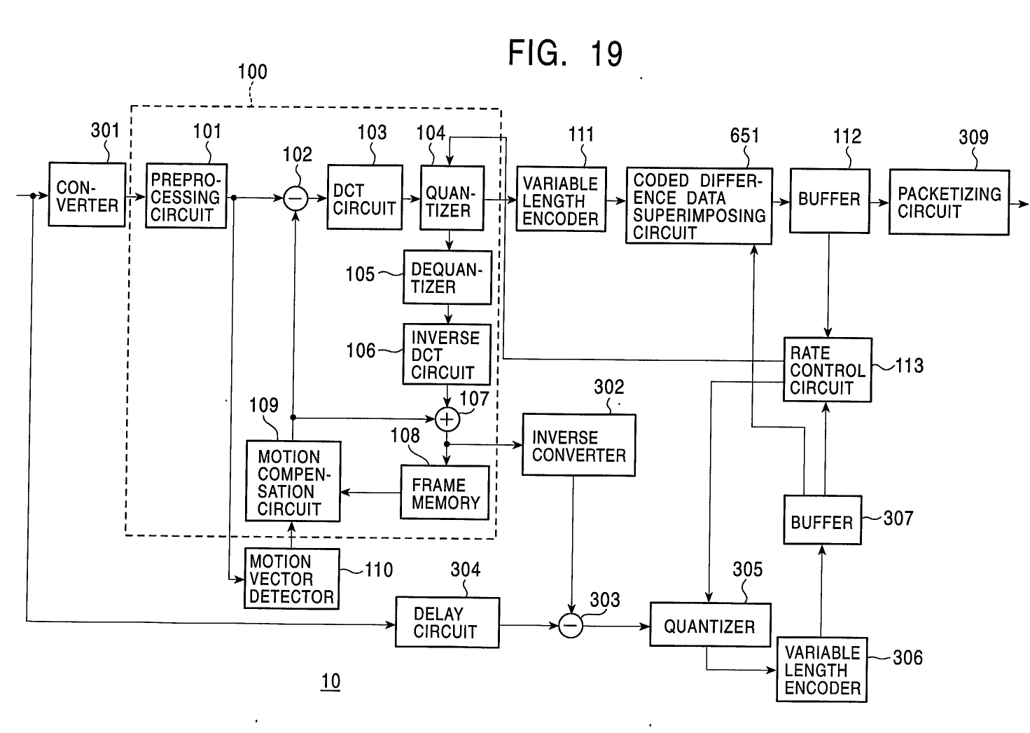

FIG. 18 illustrates a sixth embodiment of the image encoder 10 according to the invention. In FIG. 18, similar parts to those in FIG. 12 are denoted by similar reference numerals. This image encoder 10 includes an inverse converter 632 consisting of N inverse converters 632-1 to 632-N. Furthermore, a selection circuit 641 and a selection data output circuit 642 are disposed at stages following the inverse converter 632. The other parts are similar to those in FIG. 12.

The inverse converters 632-1 to 632-N produce motion vectors for use in producing interpolated frames in different manners on the basis of motion vectors supplied from the motion vector detectors 631 and produces interpolated frames in the manners assigned to the respective inverse converters. The selection circuit 641 selects one of the inverse converters 632-1 to 632-N. That is, one inverse converter 632-i selected by the selection circuit 641 produces motion vectors used to produce interpolated frames in the manner assigned to the inverse converter 632-i and produces interpolated frames in accordance with the obtained motion vectors.

The selection circuit 641 sends identification information (i) of the selected inverse converter 632-i to the selection data output circuit 642. The selection data output circuit 642 transfers the identification information of the inverse converter 632-i received from the selection circuit 641 to the packetizing circuit 308. The packetizing circuit 308 adds the received identification information to the header of the coded difference data and outputs the resultant data to the modulator 11.

In this embodiment, as described above, motion vectors used to produce interpolated frames are produced in different manners, and interpolated frames are produced in accordance with the obtained motion vectors.

FIG. 19 illustrates a seventh embodiment of the image encoder 10 according to the invention. In FIG. 19, similar parts to those in FIG. 2 are denoted by similar reference numerals. As shown in FIG. 19, the image encoder 10 includes a coded difference data superimposing circuit 651 disposed between the variable length encoder 111 and the buffer 112, wherein the output of the buffer 307 is supplied to the coded difference data superimposing circuit 651. On the other hand, the image encoder 10 does not have the packetizing circuit 308. The other parts are similar to those in FIG. 2.

The coded difference data superimposing circuit 651 superimposes the coded image data output from the variable length encoder 111 and the coded difference data supplied from the variable length encoder 306 via the buffer 307. The resultant superimposed data is output to the buffer 112. The buffer 112 temporarily stores the superimposed coded data received from the coded difference data superimposing circuit 651 and sequentially outputs it at a predetermined rate to the packetizing circuit 309. The packetizing circuit 309 packetizes the superimposed coded data thereby producing a superimposed coded data packet T as shown in FIG. 20. The resultant packet T is output to the modulator 11.

The superimposed coded data packet T consists of a header section TH, a coded difference data section TR, and a coded image data section TQ. Data similar to that stored in the coded image data section QD shown in FIG. 4 is stored in the coded image data section TQ, and data similar to that stored in the coded difference data section RD shown in FIG. 4 is stored n the coded difference data section TR. The header section TH includes information indicating the start point A of the coded image data section TQ in the superimposed coded data packet T as well as information indicating that the packet includes coded image data and coded difference data in a superimposed fashion. The value of the start point A can be reduced by placing the coded image data section TQ at a location following the coded difference data section TR. The end point B of the coded image data section TQ can be detected from the header section TH of the following superimposed coded data packet T. Therefore, the header section TH includes no information indicating the end point B of the coded image data section TQ.

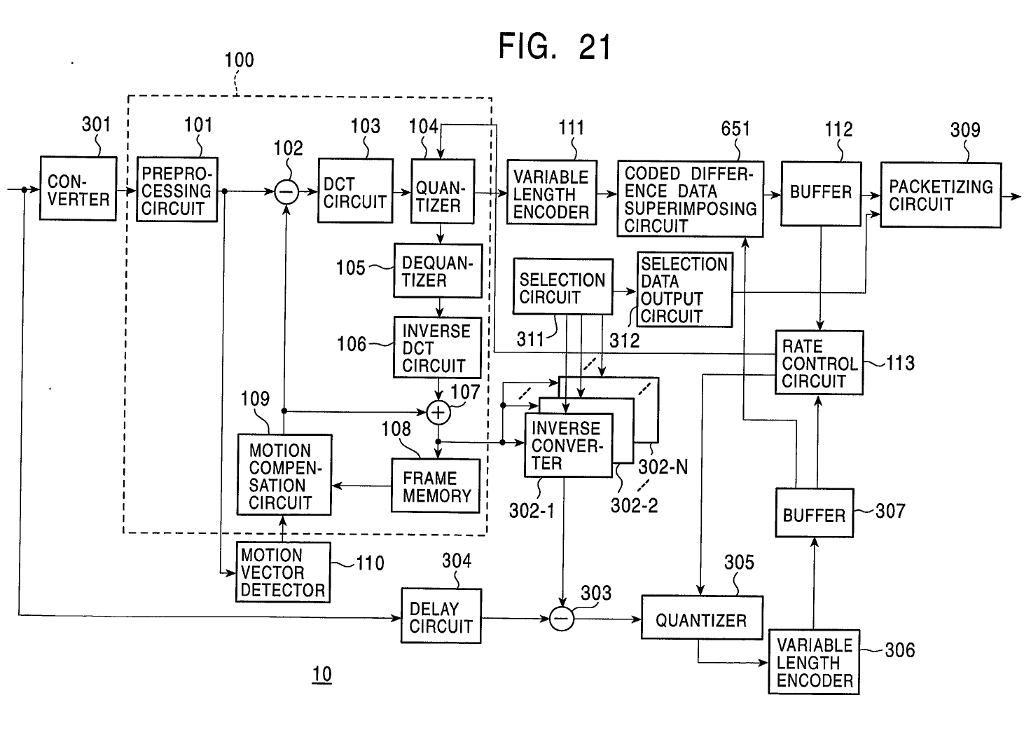

FIG. 21 illustrates an eighth embodiment of the image encoder 10 according to the present invention. In FIG. 21, similar parts to those in FIG. 6 or 19 are denoted by similar reference numerals. The eight embodiment of the image encoder 10 is obtained by combining the second and seventh embodiments.

An inverse converter 302-i selected by the selection circuit 311 performs frame rearrangement and frame interpolation upon image data output from the adder 107. The resultant data is output to the subtractor 303. The subtractor 303 calculates the differences between the frames of the sequentially scanning image data output from the delay circuit 304 and corresponding frames of the image data output from the inverse converter 302-i thereby producing difference data. The difference data output from the subtractor 303 is supplied to the quantizer 305. The quantizer 305 quantizes the received difference data and outputs the resultant data to the variable length encoder 306. The variable length encoder performs variable length encoding upon the received data.

The coded difference data superimposing circuit 651 superimposes the coded image data output from the variable length encoder 111 and the coded difference data supplied from the variable length encoder 306 via the buffer 307. The resultant superimposed data is output to the buffer 112. The buffer 112 temporarily stores the superimposed coded data received from the coded difference data superimposing circuit 651 and sequentially outputs it at a predetermined rate to the packetizing circuit 309. The packetizing circuit 309 packetizes the superimposed coded data thereby producing a superimposed coded data packet T as shown in FIG. 20. The resultant packet T is output to the modulator 11.

The coded difference data superimposing circuit 651 superimposes the coded image data output from the variable length encoder 111 and the coded difference data supplied from the variable length encoder 306 via the buffer 307 thereby producing superimposed coded data. The resultant superimposed coded data is supplied to the packetizing circuit 309 via the buffer 112.

The selection circuit 611 selects one of the inverse converters 302-1 to 302-N and outputs identification information (i) of the selected inverse converter 302-i to the selection data output circuit 312. The selection data output circuit 312 transfers the identification information of the inverse converter 302-i received from the selection circuit 311 to the packetizing circuit 309. The packetizing circuit 309 adds the received identification information to the header of the superimposed coded.

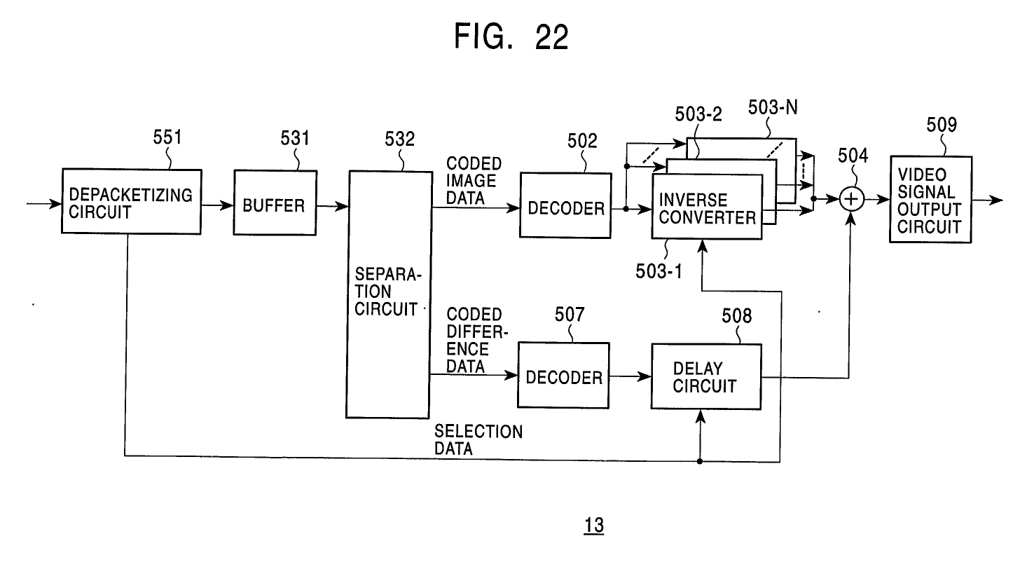

Referring now to FIG. 22, a third embodiment of the image decoder 13 corresponding to the eighth embodiment of the image encoder 10 (FIG. 21) is described below, wherein the operation of processing the superimposed coded image data and the selection data received via the modulator 11 and the demodulator 12 from the image encoder 10 according to the eighth embodiment is also described. In FIG. 22, similar parts to those in FIG. 7 are denoted by similar reference numerals.

The superimposed coded data, which has been transmitted after being encoded by the image encoder 10 shown in FIG. 21, is depacketized by the depacketizing circuit 551 and input to the buffer 531. Selection data indicating the inverse converter 302-i shown in FIG. 21 selected in the encoding process is extracted from the header by the depacketizing circuit 551 and input to the inverse converters 503-1 to 503-N and also to the delay circuit 508.

The buffer 531 temporarily stores the superimposed coded data input to the buffer 531 and outputs it at a predetermined rate to a separation circuit 532. The separation circuit 532 separates the superimposed coded data supplied from the buffer 531 into coded image data and coded difference data. The coded image data output from the separation circuit 532 is supplied to a decoder 502 and decoded. On the other hand, the coded difference data output from the separation circuit 532 is supplied to a decoder 507 and decoded. After that, the coded image data and the coded difference data are processed in a similar manner as described above with reference to FIG. 7, and finally a video signal is reproduced by a video signal output circuit 509.

FIG. 23 illustrates a ninth embodiment of the image encoder 10 according to the present invention. In FIG. 23, similar parts to those in FIG. 21 are denoted by similar reference numerals.

The selection data output circuit 312 produces selection data by converting the identification information received from the selection circuit 311 into a predetermined format. The resultant selection data is output to the coded difference data superimposing circuit 651.

The coded difference data superimposing circuit 651 superimposes the selection data output from the selection data output circuit 312, the coded image data output from the variable length encoder 111, and the coded difference data supplied from the variable length encoder 306 via the buffer 307. The resultant superimposed data is output to the packetizing circuit 309 via the buffer 112. The packetizing circuit 309 packetizes the superimposed coded data and outputs the resultant data to the modulator 11.

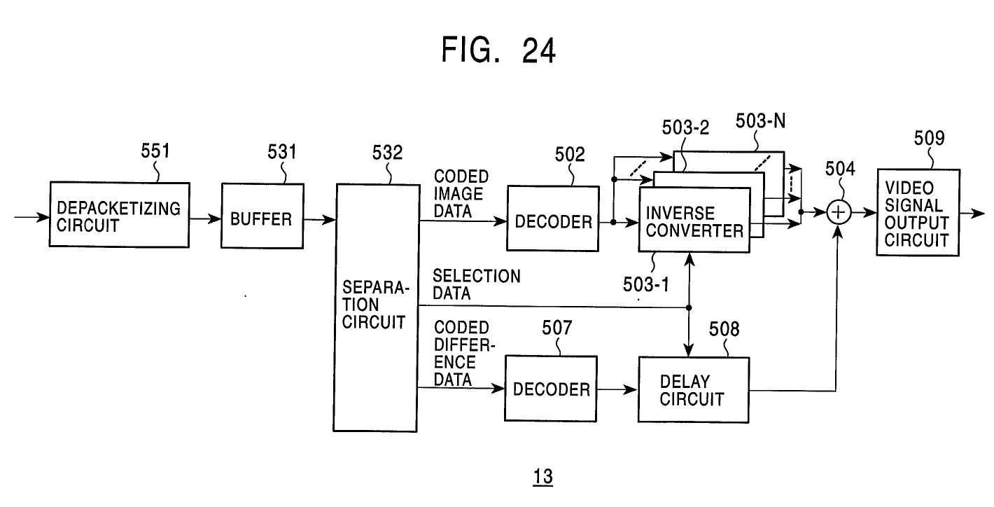

Referring now to FIG. 24, a fourth embodiment of the image decoder 13 corresponding to the ninth embodiment of the image encoder 10 is described below, wherein the operation of processing superimposed coded data including coded image data, coded difference data, and selection data received via the modulator 11 and the demodulator 12 from the ninth embodiment of the image encoder 10 according to the invention is also described. In FIG. 24, similar parts to those in FIG. 22 are denoted by similar reference numerals.

The superimposed coded data, which has been transmitted after being encoded by the image encoder 10 shown in FIG. 23, is depacketized by the depacketizing circuit 551 and input to the separation circuit 532 via the buffer 531. The separation circuit 532 separates the superimposed coded data into coded image data, coded difference data, and selection data. The separated coded image data and coded difference data are supplied to the decoders 502 and 507, respectively, and the separated selection data is supplied to the inverse converters 503-1 to 503-N and also to the delay circuit 508. After that, processing is performed in a similar manner as described above with reference to FIG. 22, and finally a video signal is reproduced by a video signal output circuit 509.

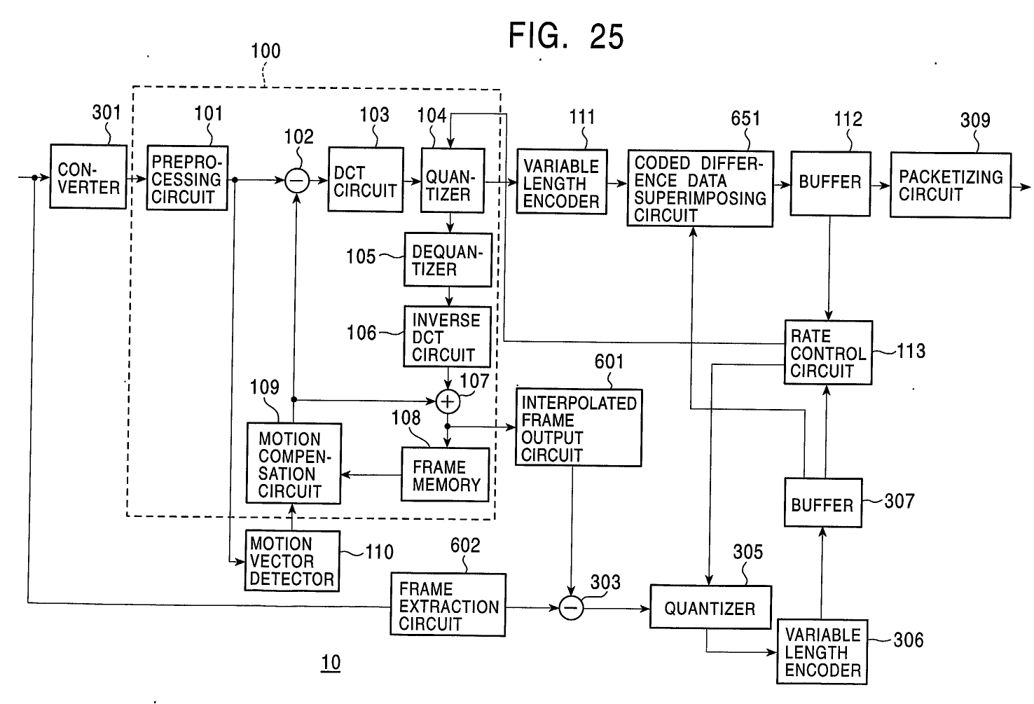

FIG. 25 illustrates a tenth embodiment of the image encoder 10 according the present invention. In FIG. 25, similar parts to those in FIG. 19 are denoted by similar reference numerals. In this image encoder 10, the inverse converter 302 and the delay circuit 304 are replaced with the interpolated frame output circuit 601 and the frame extraction circuit 602 shown in FIG. 8 or 10, respectively. The other parts are similar to those in FIG. 19.

Difference data is produced on the basis of interpolated frames output from the interpolated frame output circuit 601. The produced difference data is quantized by the quantizer 305 and then subjected to variable length encoding in the variable length encoder 306. Thus, coded difference data is obtained.

The coded difference data superimposing circuit 651 superimposes the coded image data output from the variable length encoder 111 and the coded difference data supplied from the variable length encoder 306 via the buffer 307 thereby producing superimposed coded data.

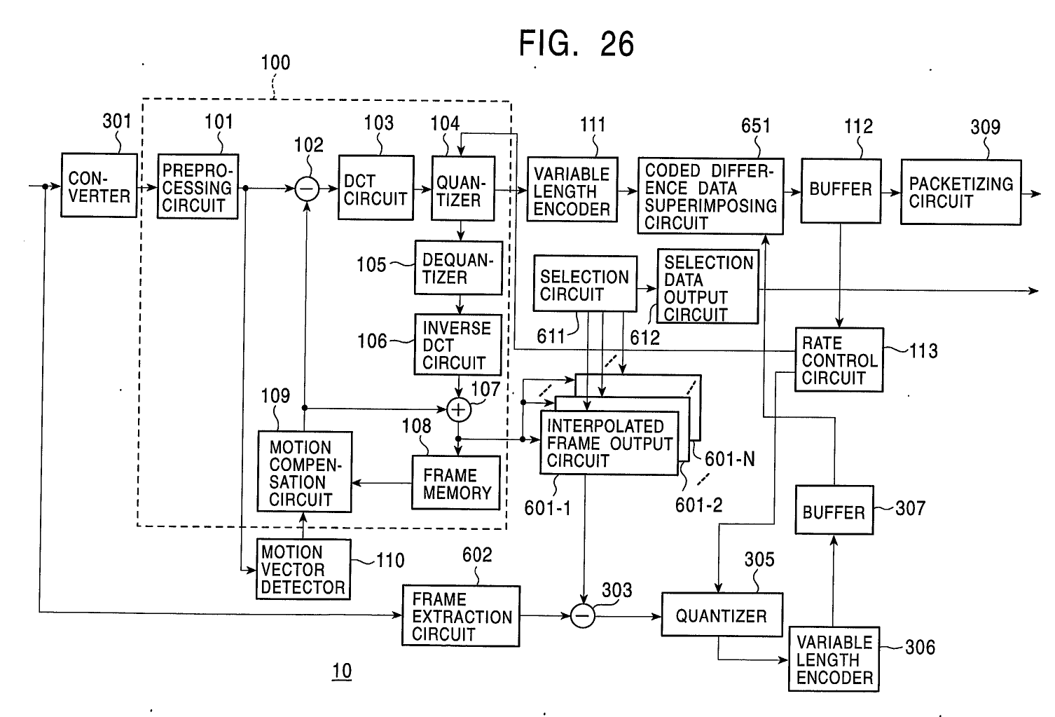

FIG. 26 illustrates an eleventh embodiment of an image encoder 10 according the present invention. In FIG. 26, similar parts to those in FIG. 10 or 25 are denoted by similar reference numerals. As can be seen from FIG. 26, this image encoder 10 is obtained by combining the fourth and tenth embodiments of the image encoder 10, and the functions and advantages will be apparent from FIG. 26 although any further description is not given here.

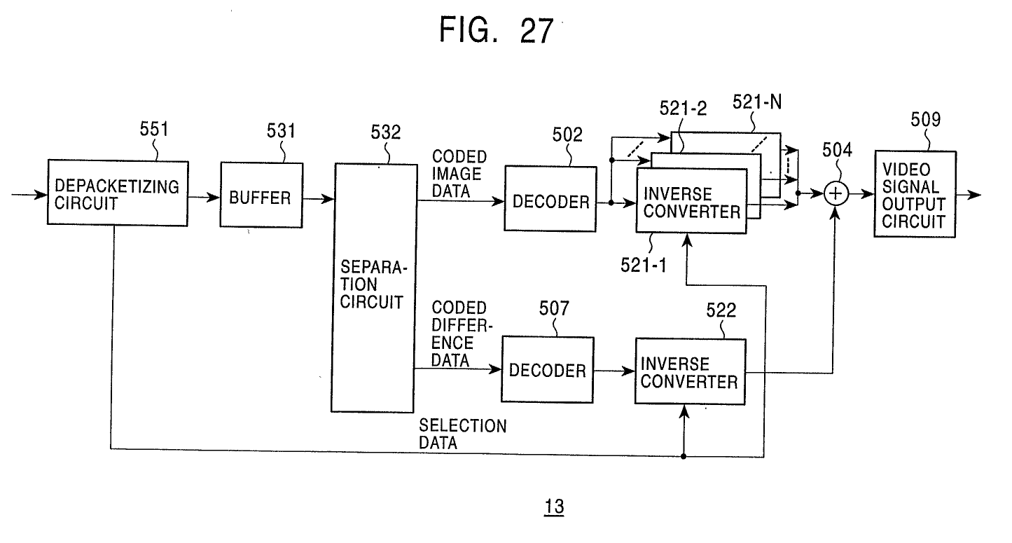

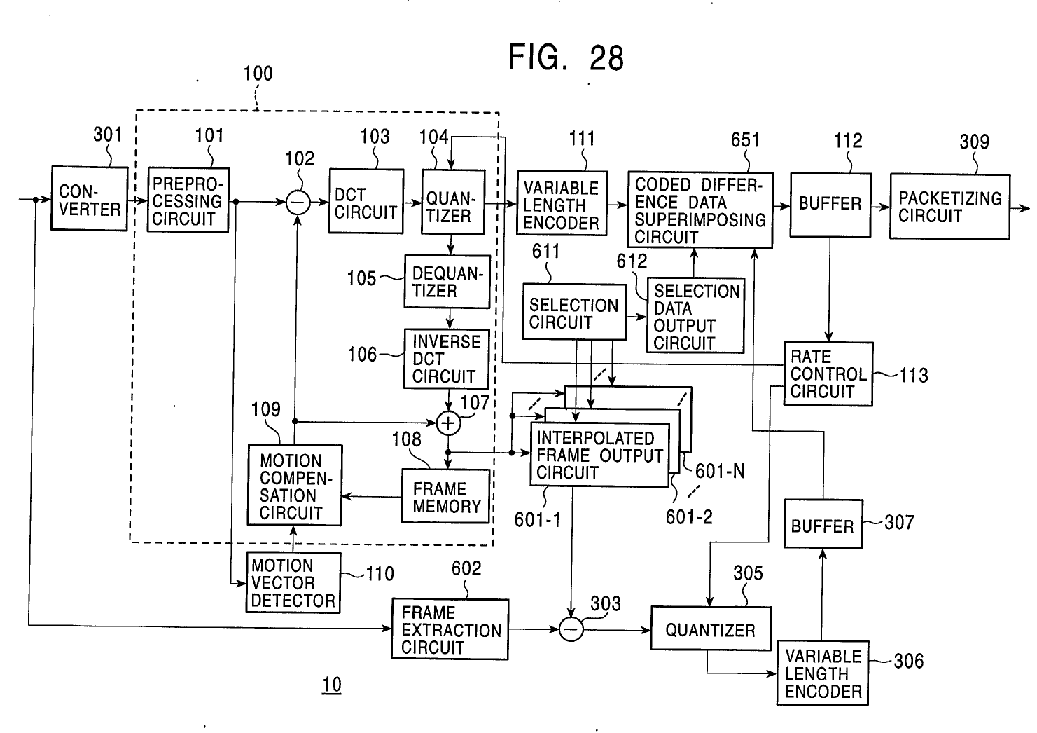

FIG. 27 illustrates a fifth embodiment of the image decoder 13 corresponding to the eleventh embodiment of the image encoder 10 according to the invention. In FIG. 27, similar parts to those in FIG. 11 or 22 are denoted by similar reference numerals. As can be seen from FIG. 27, this image decoder 13 is obtained by combining the second and third embodiments of the image decoder 13, and the functions and advantages will be apparent from FIG. 27, although any further description is not given here.

FIG. 28 illustrates a twelfth embodiment of the image encoder 10 according the present invention. In FIG. 28, similar parts to those in FIG. 23 are denoted by similar reference numerals. In this image encoder 10, the inverse converter 302 and the delay circuit 304 are replaced with the interpolated frame output circuit 601 and the frame extraction circuit 602 shown in FIG. 10 or 26, respectively. The other parts are similar to those in FIG. 23, and they are not described in further detail.

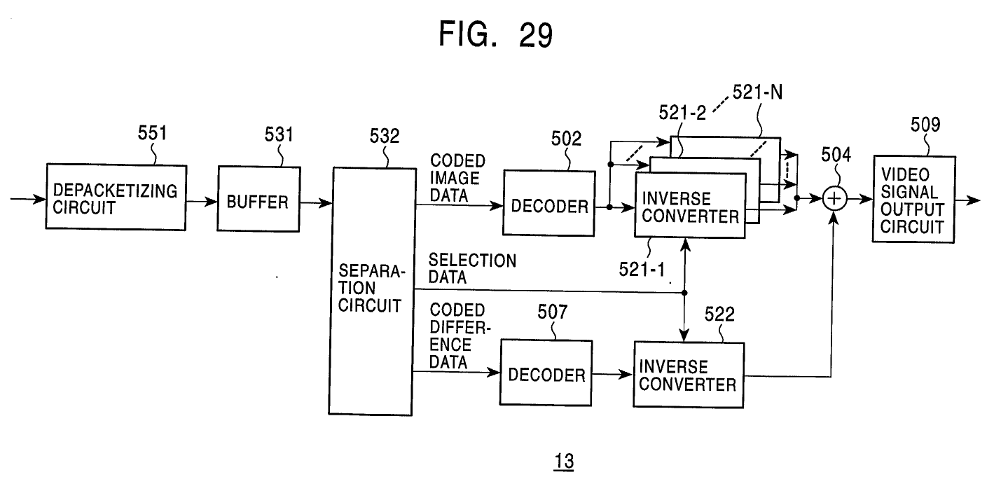

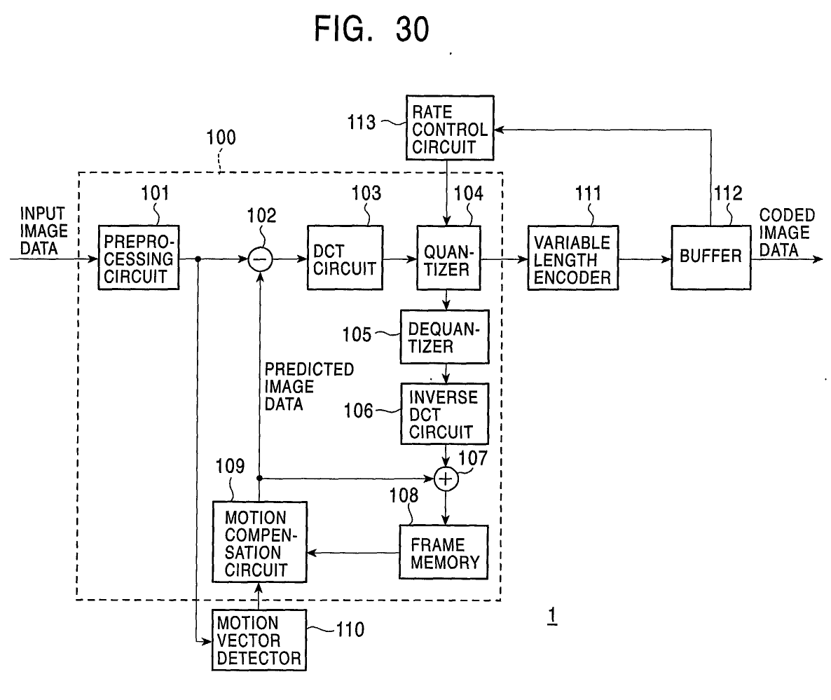

FIG. 29 illustrates a sixth embodiment of the image decoder 13 corresponding to the twelfth embodiment of the image encoder 10 (FIG. 28) according to the invention. In FIG. 29, similar parts to those in FIG. 24 are denoted by similar reference numerals. In this image decoder 13, the delay circuit 508 is replaced with the inverse converter 522 shown in FIG. 11 or 27. The other parts are similar to those in FIG. 24, and they are not described in further detail.

The computer program according to which the above process is performed may be stored on a supplying medium for supplying the computer program. Supplying media which can be employed for such a purpose include a storage medium such as a magnetic disk, a CD-ROM, and a solid-state memory, and a communication medium such as a network, a satellite, etc.

As can be understood from the above description, the present invention has great advantages. That is, the image processing apparatus according to the first aspect, the image processing method according to the second aspect, and the supplying medium according to the third aspect have the advantage that high-efficiency encoding of image data is achieved by partially removing frames from the image data thereby converting the frame rate. The image processing apparatus according to the fourth aspect, the image processing method according to the fifth aspect, and the supplying medium according to the sixth aspect have the advantage that the frame rate of coded image data is converted to the original value thereby ensuring that the coded image data can be decoded in a highly reliable fashion.

What is claimed is:

1. An image processing apparatus comprising:
producing means for producing second image data with a second frame rate by partially removing frames of first image data with a first frame rate;
first encoding means for encoding said second image data;
interpolated frame producing means for producing an interpolated frame from decoded image data obtained by decoding said second image data encoded by said first encoding means;
calculating means for calculating the difference between said first image data and the image data of said interpolated frame produced by said interpolated frame producing means; and
second encoding means for encoding said difference calculated by said calculating means.

2. An image processing apparatus according to claim 1, wherein said interpolated frame producing means produces the interpolated frame by averaging images of adjacent frames of the decoded image data obtained by decoding said second image data.

3. An image processing apparatus according to claim 1, wherein said interpolated frame producing means produces the interpolated frame on the basis of a motion vector associated with a frame of the decoded image data obtained by decoding said second image data.

4. An image processing apparatus according to claim 1, further comprising superimposing means for superimposing said second image data encoded by said first encoding means and said difference encoded by said second encoding means.

5. An image processing method comprising:
a producing step for producing second image data with a second frame rate by partially removing frames of first image data with a first frame rate;
a first encoding step for encoding said second image data;
an interpolated frame producing step for producing an interpolated frame from decoded image data obtained by decoding said second image data encoded in said first encoding step;
a calculating step for calculating the difference between said first image data and the image data of said interpolated frame produced in said interpolated frame producing step; and
a second encoding step for encoding said difference calculated in said calculating step.

6. A supplying medium for supplying a computer readable program executed by an image processing apparatus to perform a process comprising:
a producing step for producing second image data with a second frame rate by partially removing frames of first image data with a first frame rate;
a first encoding step for encoding said second image data;
an interpolated frame producing step for producing an interpolated frame from decoded image data obtained by decoding said second image data encoded in said first encoding step;
a calculating step for calculating the difference between said first image data and the image data of said interpolated frame produced in said interpolated frame producing step; and
a second encoding step for encoding said difference calculated in said calculating step.

7. An image processing apparatus comprising:
conversion means for converting the frame rate of received coded image data, whose frame rate has been converted from a first frame rate to a second frame rate, into an original frame rate;
producing means for producing difference data for use in decoding said coded image data; and
decoding means for decoding said coded image data on the basis of said difference data produced by said producing means.

8. An image processing method comprising: a conversion step for converting the frame rate of received coded image data, whose frame rate has been converted from a first frame rate to a second frame rate, into an original frame rate;
a producing step for producing difference data for use in decoding said coded image data; and
a decoding step for decoding said coded image data on the basis of said difference data produced in said producing step.

9. A supplying medium for supplying a computer readable program executed by an image processing apparatus to perform a process comprising:
a conversion step for converting the frame rate of received coded image data, whose frame rate has been converted from a first frame rate to a second frame rate, into an original frame rate;
a producing step for producing difference data for use in decoding said coded image data; and
a decoding step for decoding said coded image data on the basis of said difference data produced in said producing step.
